(19) United States
(12) Patent Application Publication
(10) Pub. No.: US 2025/0355311 A1
(43) Pub. Date: Nov. 20, 2025

(54) ELECTRONIC DEVICE

(71) Applicants: InnoLux Corporation, Miao-Li County (TW); CARUX TECHNOLOGY PTE. LTD., APERIA (SG)

(72) Inventors: Li-Wei SUNG, Tainan (Tainan Science Park) (TW); Cheng-Tso CHEN, Miao-Li County (TW); Yu-Ti HUANG, Miao-Li County (TW); Kuei-Chen CHIU, Miao-Li County (TW); Pin-Lin CHENG, Miao-Li County (TW)

(21) Appl. No.: 19/176,619

(22) Filed: Apr. 11, 2025

(30) Foreign Application Priority Data
May 15, 2024 (CN) 202410601405.4

(51) Int. Cl. G02F 1/29

(52) U.S. Cl. CPC G02F 1/29

(57) ABSTRACT

An electronic device is provided. The electronic device includes a light-controlling structure, and the light-controlling structure includes a substrate, a first light-adjusting layer, and a second light-adjusting layer. The first light-adjusting layer is disposed on a first surface of the substrate, wherein the first light-adjusting layer has a first light-transmitting area. The second light-adjusting layer is disposed on the first light-adjusting layer, wherein the second light-adjusting layer has a second light-transmitting area, and the first light-transmitting area partially overlaps the second light-transmitting area. In a first direction, the first light-transmitting area has a first edge away from a first reference position, and the second light-transmitting area has a second edge away from the first reference position, a first offset is between the first edge and the second edge, and the first offset is greater than 0.

### CROSS REFERENCE TO RELATED APPLICATIONS

This application claims priority of China Patent Application No. 202410601405.4, filed on May 15, 2024, the entirety of which is incorporated by reference herein.

### BACKGROUND

### Technical Field

The present disclosure relates to an electronic device, and, in particular, to an electronic device including a light-controlling structure including a light-adjusting layer.

### Description of the Related Art

Electronic devices that include display panels, such as displays, smartphones, tablets, notebook computers, and televisions, have become indispensable necessities in modern society. With the booming development of these types of electronic devices, consumers have high expectations on their quality, functionality, and price.

In general, an electronic device may include a light-controlling structure to adjust the traveling direction and/or light flux to achieve desired range of the viewing angle. Therefore, when the design of the light-controlling structure is insufficient, the visual effect of the electronic device will be reduced. For example, it may cause the user to have problems with a poor viewing angle (such as the improper position of the convergence viewing angle) and/or insufficient emitting uniformity when observing the images displayed on the display panel.

Therefore, these electronic devices do not meet consumer expectations in all respects, and there are still some problems in the electronic devices. The development of improved electronic devices is still a current goal.

### BRIEF SUMMARY

An embodiment of the present disclosure provides an electronic device. The electronic device may include a light-controlling structure. The light-controlling structure may include a substrate, a first light-adjusting layer, and a second light-adjusting layer. The first light-adjusting layer is disposed on a first surface of the substrate, wherein the first light-adjusting layer has a first light-transmitting area. The second light-adjusting layer is disposed on the first light-adjusting layer, wherein the second light-adjusting layer has a second light-transmitting area, and the first light-transmitting area partially overlaps the second light-transmitting area. In a first direction, the first light-transmitting area has a first edge away from a first reference position, and the second light-transmitting area has a second edge away from the first reference position, a first offset is between the first edge and the second edge, and the first offset is greater than 0.

The electronic devices of the present disclosure may be applied in various types of electronic apparatus. In order to make the features and advantages of some embodiments of the present disclosure more understand, some embodiments of the present disclosure are listed below in conjunction with the accompanying drawings, and are described in detail as follows.

### BRIEF DESCRIPTION OF THE DRAWINGS

The present disclosure can be more fully understood from the following detailed description when read in conjunction with the accompanying drawings. It should be noted that, according to the standard practice in the industry, the various features are not drawn to scale. In fact, the dimensions of the various features may be arbitrarily increased or reduced for clarity.

FIG. 1 is a schematic top view of a light-controlling structure according to some embodiments of the present disclosure.

FIG. 2 is a schematic cross-sectional view of a light-controlling structure according to some embodiments of the present disclosure.

FIG. 3 is a schematic cross-sectional view of a light-transmitting area of a light-controlling structure according to some embodiments of the present disclosure.

FIG. 4 is a schematic cross-sectional view of a light-controlling structure according to some embodiments of the present disclosure.

FIG. 5 is a schematic cross-sectional view of a light-transmitting area of a light-controlling structure according to some embodiments of the present disclosure.

FIG. 6 is a schematic cross-sectional view of a light-controlling structure according to some embodiments of the present disclosure.

FIG. 7 is a schematic cross-sectional view of an electronic device according to some embodiments of the present disclosure.

FIG. 8 is a schematic usage diagram of an electronic device according to some embodiments of the present disclosure.

FIGS. 9 to 11 are schematic cross-sectional views of various stages of a manufacturing process of a light-controlling structure according to some embodiments of the present disclosure, respectively.

FIG. 12 is a schematic cross-sectional view of a stage of a manufacturing process of a light-controlling structure according to some embodiments of the present disclosure.

FIGS. 13 to 15 are schematic top views of the openings of the light-controlling structure according to some embodiments of the present disclosure, respectively.

FIG. 16 is a schematic top view of a light-controlling structure according to some embodiments of the present disclosure.

FIG. 17 is a schematic cross-sectional view of a light-controlling structure according to some embodiments of the present disclosure.

FIG. 18 is a schematic top view of a light-controlling structure according to some embodiments of the present disclosure.

### DETAILED DESCRIPTION

Electronic devices of various embodiments of the present disclosure will be described in detail below. It should be understood that the following description provides many different embodiments for implementing various aspects of some embodiments of the present disclosure. The specific elements and arrangements described below are merely to clearly describe some embodiments of the present disclosure. Of course, these are only used as examples rather than limitations of the present disclosure. Furthermore, similar and/or corresponding reference numerals may be used in different embodiments to designate similar and/or corresponding elements in order to clearly describe the present disclosure. However, the use of these similar and/or corresponding reference numerals is only for the purpose of simply and clearly description of some embodiments of the present disclosure, and does not imply any correlation between the different embodiments and/or structures discussed.

It should be understood that relative terms, such as “lower”, “bottom”, “higher” or “top” may be used in various embodiments to describe the relative relationship of one element of the drawings to another element. It will be understood that if the device in the drawings were turned upside down, elements described on the “lower” side would become elements on the “upper” side. The embodiments of the present disclosure can be understood together with the drawings, and the drawings of the present disclosure are also regarded as a portion of the disclosure.

Furthermore, when it is mentioned that a first material layer is located on or over a second material layer, it may include the embodiment which the first material layer and the second material layer are in direct contact and the embodiment which the first material layer and the second material layer are not in direct contact with each other, that is one or more layers of other materials is between the first material layer and the second material layer. However, if the first material layer is directly on the second material layer, it means that the first material layer and the second material layer are in direct contact.

In addition, it should be understood that ordinal numbers such as “first”, “second” and the like used in the description and claims are used to modify elements and are not intended to imply and represent the element(s) have any previous ordinal numbers, and do not represent the order of a certain element and another element, or the order of the manufacturing method, and the use of these ordinal numbers is only used to clearly distinguished an element with a certain name and another element with the same name. The claims and the specification may not use the same terms, for example, a first element in the specification may be a second element in the claim.

In some embodiments of the present disclosure, terms related to bonding and connection, such as “connect”, “interconnect”, “bond”, and the like, unless otherwise defined, may refer to two structures in direct contact, or may also refer to two structures not in direct contact, that is there is another structure disposed between the two structures. Moreover, the terms related to connection and bonding can also include embodiments in which both structures are movable, or in which both structures are fixed. Furthermore, the terms “electrically connected” or “electrically coupled” include any direct and indirect means of electrical connection.

Herein, the terms “about”, “approximately”, and “substantially” generally mean within 10%, within 5%, within 3%, within 2%, within 1%, or within 0.5% of a given value or range. The given value is an approximate value, that is, “about”, “approximately”, and “substantially” can still be implied without the specific description of “about”, “approximately”, and “substantially”. The phrase “in a range of a first value-a second value”, “between a first value and a second value”, or “a first value to a second value (a first value-a second value)” means that the range includes the first value, the second value, and other values in between. Furthermore, any two values or directions used for comparison may have certain tolerance. If the first value is equal to the second value, it implies that there may be a tolerance within about 10%, within 5%, within 3%, within 2%, within 1%, or within 1% between the first value and the second value. If the first direction is perpendicular to the second direction, the angle between the first direction and the second direction may be between 80 degrees and 100 degrees. If the first direction is parallel to the second direction, the angle between the first direction and the second direction may be between 0 degrees and 10 degrees.

Certain terms may be used throughout the specification and claims in this disclosure to refer to specific elements. A person of ordinary skills in the art should be understood that electronic device manufacturers may refer to the same element by different terms. The present disclosure does not intend to distinguish between elements that have the same function but with different terms. In the following description and claims, terms such as “comprising”, “including”, and “having” are open-ended words, so they should be interpreted as meaning “including but not limited to . . . ”. Therefore, when the terms “comprising”, “including”, and/or “having” is used in the description of the present disclosure, it designates the presence of corresponding features, regions, steps, operations, and/or elements, but does not exclude the presence of one or more corresponding features, regions, steps, operations, and/or elements.

Unless otherwise defined, all terms (including technical and scientific terms) used herein have the same meaning as commonly understood by a person of ordinary skills in the art. It is understood that these terms, such as those defined in commonly used dictionaries, should be interpreted as having meanings consistent with the relevant art and the background or context of the present disclosure, and should not be interpreted in an idealized or overly formal manner, unless otherwise defined in the embodiments of the present disclosure.

Herein, the respective directions are not limited to three axes of the rectangular coordinate system, such as the X-axis, the Y-axis, and the Z-axis, and may be interpreted in a broader sense. For example, the X-axis, the Y-axis, and the Z-axis may be perpendicular to each other, or may represent different directions that are not perpendicular to each other, but the present disclosure is not limited thereto. For convenience of description, hereinafter, the X-axis direction is the first direction D1 (width direction), the Y-axis direction is the second direction D2 (length direction), and the Z-axis direction is the third direction D3 (height/thickness direction). In some embodiments, the schematic top views described herein are schematic views observing the XY plane, the schematic cross-sectional views described herein are schematic views observing the XZ plane or the YZ plane. In some embodiments, a normal direction of the substrate is the third direction.

In some embodiments of the present disclosure, the relative setting relationship, the depth, the thickness, the width, or the height of each element, as well as the pitch or distance between elements, may be measured using an optical microscope (OM), a scanning electron microscope (SEM), a film thickness profiler (α-step), an ellipsometer, or another suitable method. According to some embodiments, a cross-sectional structure image including an element to be measured may be obtained by using the scanning electron microscope, and then the depth, the thickness, the width, or the height of each element, and the pitch or the distance between elements, may be measured.

In the present disclosure, the electronic device may include a display module, a backlight module, an antenna module, a sensing module, or a titling module, but the present disclosure is not limited thereto. The electronic device may be a foldable or flexible electronic device. The display module may be a non-self-luminous display module or a self-luminous display module. The antenna module may be a liquid crystal antenna module or a non-liquid crystal antenna module. The sensing module may be a sensing module for sensing capacitance, light, heat, or ultrasonic waves, but the present disclosure is not limited thereto. The electronic unit may include passive elements and active elements, such as capacitors, resistors, inductors, diodes, transistors, and the like. The diodes may include light-emitting diodes or photodiodes. The light-emitting diodes may include, for example, organic light-emitting diodes (OLEDs), mini light-emitting diodes (mini LEDs), micro light-emitting diodes (micro LEDs), or quantum dot light-emitting diodes (quantum dot LED), but the present disclosure is not limited thereto. The titling module may be, for example, a display titling module or an antenna titling module, but the present disclosure is not limited thereto.

In addition, the shape of the electronic device may be rectangular, circular, polygonal, a shape with curved edges, or another suitable shape. The electronic device may have a peripheral system, such as a processing system, a driving system, a control system, a light source system, a shelf system, or the like to support the display module or titling module.

It should be understood that, for clarity of explanation, some elements of the electronic device may be omitted in the drawings, and only some elements are schematically illustrated. In some embodiments, additional elements may be added to the electronic device described below. In other embodiments, some elements of the electronic device described below may be replaced or omitted.

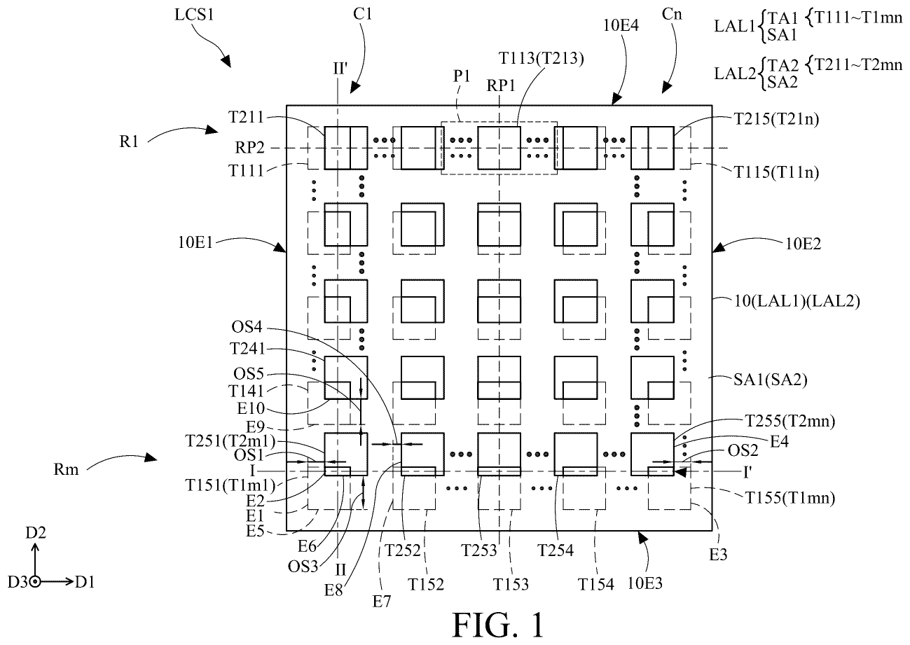

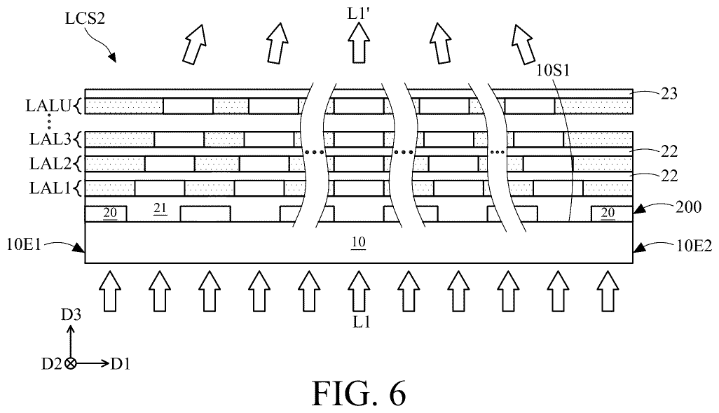

Referring to FIG. 1, which is a schematic top view of a light-controlling structure LCS1 according to some embodiments of the present disclosure. In some embodiments, a light-controlling structure LCS1 may include the substrate 10, a first light-adjusting layer LAL1, and a second light-adjusting layer LAL2. According to some embodiments, the light-controlling structure LCS1 may include a plurality of light-adjusting layers, as described in FIG. 6. For convenience of explanation, two light-adjusting layers (for example, the first light-adjusting layer LAL1 and the second light-adjusting layer LAL2) are used as an example for description, but the present disclosure is not limited thereto. The first light-adjusting layer LAL1 may be disposed on a first surface 10S1 of the substrate 10. The second light-adjusting layer LAL2 may be disposed on the first light-adjusting layer LAL1. The first light-adjusting layer LAL1 may be disposed between the substrate 10 and the second light-adjusting layer LAL2. The first direction D1 and the second direction D2 constitute the first surface 10S1 of the substrate 10. The third direction D3 is the thickness direction of the substrate 10 or the normal direction of the substrate 10. The first direction D1, the second direction D2, and the third direction D3 are different. For example, the first direction D1, the second direction D2, and the third direction D3 are perpendicular to each other.

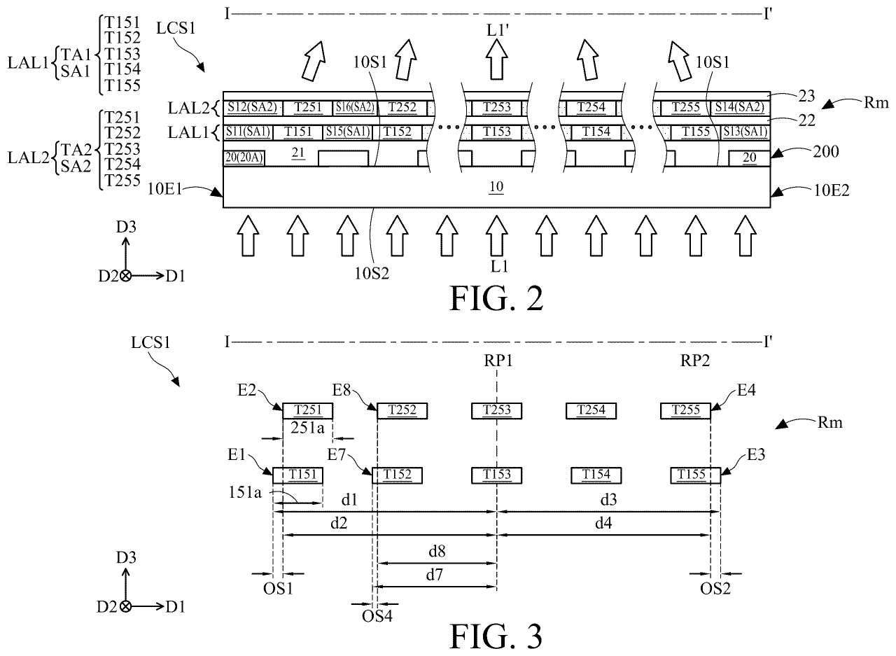

FIG. 2 is a schematic cross-sectional view along line segment I-I′ in shown FIG. 1. As shown in FIGS. 1 and 2, on the first surface 10S1, the substrate 10 may include a first side 10E1 and a second side 10E2 disposed opposite to the first side 10E1. The first side 10E1 and the second side 10E2 extend along the second direction D2. The substrate 10 may include a third side 10E3 and a fourth side 10E4 disposed opposite to the third side 10E3. The third side 10E3 and the fourth side 10E4 extend along the first direction D1. The first side 10E1 is connected between the third side 10E3 and the fourth side 10E4, the third side 10E3 is connected between the first side 10E1 and the second side 10E2, and the second side 10E2 is connected between the third side 10E3 and the fourth side 10E4. For convenience of explanation, the above-mentioned substrate 10 is rectangular as an example. However, according to other embodiments, the shape of the substrate 10 is not limited thereto. For example, the shape of the substrate 10 may include an arc side. In this case, at least one of the above-mentioned sides (for example, the first side 10E1 to the fourth side 10E4) may include an arc.

In some embodiments, the substrate 10 may include glass, ceramic, quartz, sapphire, acrylic resin, polyimide (PI), polyethylene terephthalate (PET), polycarbonate (PC), polypropylene (PP), the like, or a combination thereof, but the present disclosure is not limited thereto. In some embodiments, the substrate 10 may include a light-transmitting substrate. For example, the substrate 10 may include glass.

As shown in FIG. 1, in some embodiments, the first light-adjusting layer LAL1 may have a plurality of light-shielding areas SA1 and a plurality of light-transmitting areas TA1. The plurality of light-shielding areas SA1 may be disposed adjacent to the plurality of light-transmitting areas TA1. As shown in FIG. 1, in some embodiments, the first light-adjusting layer LAL1 may include the plurality of light-transmitting areas TA1. For example, light-transmitting areas T111-T1mn and the plurality of light-transmitting areas may be arranged in an m×n matrix that has m rows and n columns. The direction of the row is along the first direction D1, and the direction of the column is along the second direction D2. Wherein, m may be a positive integer ranging from 5 to 10000, and n may be a positive integer ranging from 5 to 10000. For example, m and n may independently be positive integer ranging from 10 to 8000, m and n may independently be positive integer ranging from 20 to 7000, m and n may independently be a positive integer ranging from 50 to 7000, m and n may independently be a positive integer ranging from 80 to 5000, m and n may independently be a positive integer ranging from 100 to 3000, and m and n may independently be a positive integer ranging from 150 to 2000. Wherein, m and n may be equal or unequal.

For convenience of explanation, FIG. 2 only shows five light-transmitting areas among the plurality of light-transmitting areas TA1 and six light-shielding areas among the plurality of light-shielding areas SA1 in the first light-adjusting layer LAL1. The area outside the plurality of light-transmitting areas TA1 may be the plurality of light-shielding areas SA1. In other words, one light-transmitting area TA1 may be surrounded by the plurality of light-shielding areas SA1. For example, in FIG. 2, the light-transmitting area T151 is surrounded by the light-shielding areas S11 and S15.

In some embodiments, for a visible light (for example, a light with a wavelength of 380 nm-780 nm), a visible light absorbance (absorption rate) or a visible light blocking rate of the light-shielding area SA1 may be any value between 80% and 99.99%, for example, between 82% and 99.99%, between 85% and 99.99%, between 90% and 99.99%, between 95% and 99.99%, between 82% and 99.99%, between 85% and 99.99%, between 90% and 99.99%, and between 95% and 99.99%, but the present disclosure is not limited thereto. In some embodiments, for the visible light, the visible light transmittance (transmitting rate) of the light-transmitting area TA1 may be any value between 80% and 99.99%, for example, between 82% and 99.99%, between 85% and 99.99%, between 90% and 99.99%, and between 95% and 99.99%, but the present disclosure is not limited thereto.

As shown in FIG. 1, in some embodiments, the second light-adjusting layer LAL2 may be disposed on the first light-adjusting layer LAL1. In some embodiments, the second light-adjusting layer LAL2 may have light-shielding areas SA2 and light-transmitting areas TA2. In some embodiments, for the visible light, the visible light absorbance or the visible light blocking rate of the light-shielding area SA2 may refer to the above description of the light-shielding area SA1, which will not be described again here for simplification. In some embodiments, for the visible light, the visible light transmittance of the light-transmitting area TA2 may refer to the above description of the light-transmitting area TA1, which will not be described here. In some embodiments, the light-transmitting area TA1 may partially overlap the light-transmitting area TA2. In some embodiments, the light-transmitting area TA1 may be partially not overlapped the light-transmitting area TA2. In some embodiments, the visible light absorbance (or the visible light blocking rate) of the light-shielding area SA1 and the light-shielding area SA2 may be equal or unequal, and the visible light transmittances of the light-transmitting area TA1 and the light-transmitting area TA2 may be equal or unequal. For convenience of explanation, FIG. 2 only shows five light-transmitting areas among the plurality of light-transmitting areas TA2 and six light-shielding areas among the plurality of light-shielding areas SA2 in the second light-adjusting layer LAL2. The area outside the plurality of light-transmitting areas TA2 may be the plurality of light-shielding areas SA2. In other words, one light-transmitting area TA2 may be surrounded by the plurality of light-shielding areas SA2. For example, in FIG. 2, the light-transmitting area T251 is surrounded by the light-shielding areas S12 and S16.

FIG. 2 shows a schematic cross-sectional view taken along line segment I-I′ shown in FIG. 1. In some embodiments, as shown in FIGS. 1 and 2, a first light L1 (an incident light) may enter from the lower surface of the light-controlling structure LCS1 and emit light toward the upper surface of the light-controlling structure LCS1. As shown in FIG. 1, in some embodiments, the light-controlling structure LCS1 may have a first expected (desired) viewing angle position P1. The first light L1 passes through the light-controlling structure LCS1, and an emitted light L1′ is emitted from the light-controlling structure LCS1. The emitted light L1′ at the first expected viewing angle position P1 may have greater brightness (than at other positions), for example, the maximum brightness. The first expected viewing angle position P1 may be a point or an area. For example, as shown in FIG. 1, the first expected viewing angle position P1 may overlap the light-transmitting area T113 (also referred as a seventh light-transmitting area) in the first light-adjusting layer LAL1, and may overlap the light-transmitting area T113 (also referred as an eighth light-transmitting area) in the second light-adjusting layer LAL2. According to some embodiments, compared with other positions, the emitted light L1′ at the positions of the seventh light-transmitting area T113 and the eighth light-transmitting area T213 may have greater brightness. For example, compared with the first light-transmitting area T151 and the second light-transmitting area T251, the emitted light L1′ at the positions of the seventh light-transmitting area T113 and the eighth light-transmitting area T213 may have greater brightness.

In some embodiments, based on the first expected viewing angle position P1, a first reference position RP1 may be defined in the first direction D1. As shown in FIG. 1, the first reference position RP1 may be a first reference line, and the first reference line may extend along the second direction D2. In some embodiments, the first reference position RP1 may pass through the first expected viewing angle position P1. For example, the first reference position RP1 may pass through a center of the first expected viewing angle position P1.

In some embodiments, based on the first expected viewing angle position P1, a second reference position RP2 may be defined in the second direction D2. As shown in FIG. 1, the second reference position RP2 may be a second reference line, and the second reference line may extend along the first direction D1. In some embodiments, the second reference position RP2 may pass through the first expected viewing angle position P1. For example, the second reference position RP2 may pass through a center of the first expected viewing angle position P1. In some embodiments, the first expected viewing angle position P1 may be at the intersection of the first reference position RP1 and the second reference position RP2.

As shown in FIG. 2, the electronic device may include a reflective layer 200, a light-transmitting layer 21, and a light-transmitting layer 22. The reflective layer 200 may be disposed between the substrate 10 and the first light-adjusting layer LAL1, and the light-transmitting layer 22 may be disposed between the first light-adjusting layer LAL1 and the second light-adjusting layer LAL2. The light-transmitting layer 21 may be disposed on the reflective layer 200. In detail, the reflective layer 200 may include a plurality of reflective units 20 and a plurality of openings, and the openings may be disposed between two adjacent reflective units 20. According to some embodiments, at least a portion of the light-transmitting layer 21 may be disposed within the opening of the reflective layer 200. According to some embodiments, one reflective unit 20 may be disposed so that it corresponds to one light-shielding area SA1. For example, in the third direction D3, the reflective unit 20A may at least partially overlap the light-shielding area S11. One reflective unit 20 may be disposed so that it corresponds to one light-shielding area SA2. For example, in the third direction D3, the reflective unit 20A may at least partially overlap the light-shielding area S11 and the light-shielding area S12. The light-transmitting layer 23 may be disposed on the second light-adjusting layer LAL2. As shown in FIG. 2, in the first direction D1, the width of the light-shielding area S12 (also referred as a second light-shielding area) may be greater than the width of the light-shielding area S11 (also referred as a first light-shielding area).

Hereinafter, for convenience of explanation and to simplify the representation of reference numerals, the light-transmitting areas of the first light-adjusting layer LAL1 only shows an example in which m is 5 and n is 5. For example, as shown in FIGS. 1 and 2, in the first light-adjusting layer LAL1, the plurality of light-transmitting areas TA1 include: the light-transmitting area T111 (in the first row R1 and in the upper left corner) . . . the light-transmitting area T113 (in the middle of the first row R1) . . . the light-transmitting area T115 (T11n) (in the first row R1 and in the upper right corner) . . . to the light-transmitting area T151 (T1m1) (in the last row Rm and in the lower left corner), the light-transmitting area T152, the light-transmitting area T153, the light-transmitting area T154, and the light-transmitting area T155 (T1mn) (in the last row Rm and in the lower right corner). Compared with the last row Rm, the first row R1 is closer to the fourth side 10E4 of the substrate 10. However, in an actual application situations, m is not equal to 5 and n is not equal to 5. In an actual application where m is greater than 5 and n is greater than 5, please note that the above-mentioned light-transmitting area T151 (T1m1) (in the lower left corner), light-transmitting area T152, light-transmitting area T153, light-transmitting area T154, and the light-transmitting area T155 (T1mn) (in the lower right corner) may represent the light-transmitting area in the m^{th} row (for example, the last row Rm), but this does not represent the light-transmitting area in the 5^{th} row. The light-transmitting area T155 (T1mn) may represent the light-transmitting area in the n^{th} column (for example, the last column Cn), but it does not represent the light-transmitting area in the 5^{th} column. Furthermore, the light-transmitting area T153 does not represent the light-transmitting area in the third (3^{rd}) column, and the light-transmitting area T154 does not represent the light-transmitting area in the fourth (4^{th}) column. The first light-adjusting layer LAL1 includes light-transmitting areas in the first (1^{st}) column C1, for example, the light-transmitting areas T111 and T151, which may be the light-transmitting areas that are closest to the first side 10E1 of the substrate 10. Compared with the last column Cn, the first column C1 is closer to the first side 10E1 of the substrate 10. Suitable ranges for m and n are mentioned above, and they are not repeated herein.

In some embodiments, the second light-adjusting layer LAL2 may include a plurality of light-transmitting areas TA2, for example, light-transmitting areas T211-T2mn. The plurality of light-transmitting areas may be arranged in an m×n matrix, with m rows and n columns. The direction of the row is along the first direction D1, and the direction of the column is along the second direction D2. In the second light-adjusting layer LAL2, the suitable ranges of m and n in the light-transmitting areas arranged in an m×n matrix form may be referred to the relevant description of the light-transmitting areas in the first light-adjusting layer LAL1, which will not be described here.

Similar to the first light-adjusting layer LAL1, hereinafter, for convenience of explanation and to simplify the representation of reference numerals, the light-transmitting areas in the second light-adjusting layer LAL2 only shows an example in which m is 5 and n is 5. The naming method of the light-transmitting areas in the second light-adjusting layer LAL2 is similar to the naming method of the above-mentioned light-transmitting areas TA1. For example, as shown in FIGS. 1 and 2, in the second light-adjusting layer LAL2, the plurality of light-transmitting areas TA2 include: the light-transmitting area T211 (in the first row R1 and in the upper left corner) . . . the light-transmitting area T213 (in the middle of the first row R1) . . . the light-transmitting area T215 (T21n) (in the first row R1 and in the upper right corner) . . . to the light-transmitting area T251 (T2m1) (in the last row Rm and in the lower left corner), the light-transmitting area T252, the light-transmitting area T253, the light-transmitting area T254, and the light-transmitting area T255 (T2mn) (in the last row Rm and in the lower right corner). However, in an actual application situations, m is not equal to 5 and n is not equal to 5. In an actual application where m is greater than 5 and n is greater than 5, please note that the above-mentioned light-transmitting area T251 (T2m1) (in the lower left corner), light-transmitting area T252, light-transmitting area T253, light-transmitting area T254, and the light-transmitting area T255 (T2mn) (in the lower right corner) may represent the light-transmitting area in the n^{th} row (for example, the last row Rm), but this does not represent the light-transmitting area in the 5^{th} row. The light-transmitting area T255 (T2mn) may represent the light-transmitting area in the n^{th} column (for example, the last column Cn), but it does not represent the light-transmitting area in the 5^{th} column. Furthermore, the light-transmitting area T253 does not represent the light-transmitting area in the third (3^{rd}) column, and the light-transmitting area T254 does not represent the light-transmitting area in the fourth (4^{th}) column. The second light-adjusting layer LAL2 includes light-transmitting areas in the first (1^{st}) column C1, for example, the light-transmitting areas T211 and T251, which may be the light-transmitting areas that are closest to the first side 10E1 of the substrate 10.

In some embodiments, at least one or more of the light-transmitting areas T111-T1mn may correspond to the first expected viewing angle position P1, and at least one or more of the light-transmitting areas T211-T2mn may correspond to the first expected viewing angle position P1. For example, as shown in FIG. 1, in the third direction D3, the light-transmitting area T113 in the first light-adjusting layer LAL1 overlaps the first expected viewing angle position P1. In the third direction D3, the light-transmitting area T213 in the second light-adjusting layer LAL2 overlaps the first expected viewing angle position P1.

Referring to FIG. 3, which is a schematic cross-sectional view of the light-transmitting areas of the light-controlling structure LCS1 according to some embodiments of the present disclosure. FIG. 3 is a further simplified diagram of FIG. 2, showing only the light-transmitting areas.

As shown in FIGS. 2 and 3, in the light-transmitting areas of the last row Rm of the first light-adjusting layer LAL1, in the first direction D1, the light-transmitting area T151 is disposed adjacent to the light-transmitting area T152. That is, in the first direction D1, there is no other light-transmitting area between the light-transmitting area T151 and the light-transmitting area T152. The light-shielding area S15 (also referred as a fifth light-shielding area) may be disposed between the light-transmitting area T151 and the light-transmitting area T152, and the light-transmitting area T151 may be disposed between the light-shielding area S11 (also referred as the first light-shielding area) and the fifth light-shielding area S15. The first light-transmitting area T151 may be the light-transmitting area closest to the first side 10E1 of the substrate 10. Compared with the first light-transmitting area T151, the first light-shielding area S11 is closer to the first side 10E1, and the edge of the first light-shielding area S11 may be aligned with the first side 10E1.

Referring to FIGS. 1 to 3, in the light-transmitting areas of the last row Rm in the second light-adjusting layer LAL2, in the first direction D1, the light-transmitting area T251 is disposed adjacent to the light-transmitting area T252. That is, in the first direction D1, there is no other light-transmitting area between the light-transmitting area T251 and the light-transmitting area T252. The light-shielding area S16 (also referred as the sixth light-shielding area) may be disposed between the light-transmitting area T251 and the light-transmitting area T252. The light-transmitting area T251 may be disposed between the light-shielding area S12 (also referred as the second light-shielding area) and the sixth light-shielding area S16. The second light-transmitting area T251 may be the light-transmitting area closest to the first side 10E1 of the substrate 10. Compared with the second light-transmitting area T251, the second light-shielding area S12 is closer to the first side 10E1, and the edge of the second light-shielding area S12 may be aligned with the first side 10E1.

Referring to FIG. 3, in some embodiments, in the third direction D3, the light-transmitting area T151 (also referred as a first light-transmitting area) of the first light-adjusting layer LAL1 may partially overlap the light-transmitting area T251 (also referred as a second light-transmitting area) of the second light-adjusting layer LAL2 and may partially not overlap the light-transmitting area T251 (also referred as a second light-transmitting area) of the second light-adjusting layer LAL2. In some embodiments, in the first direction D1, the first light-transmitting area T151 may have a first edge E1 (located) away from the first reference position RP1, and the second light-transmitting area T251 may have a second edge E2 away from the first reference position RP1. According to some embodiments, in the first direction D1, there may be a first offset OS1 between the first edge E1 of the first light-transmitting area T151 of the first light-adjusting layer LAL1 and the second edge E2 of the second light-transmitting area T251 of the second light-adjusting layer LAL2, and the first offset OS1 may be greater than 0. In other words, the first offset OS1 is between the first edge E1 and the second edge E2. In some embodiments, in the first direction D1, there is an offset between the center of the first light-transmitting area T151 of the first light-adjusting layer LAL1 and the center of the second light-transmitting area T251 of the second light-adjusting layer LAL2. In some embodiments, in the second direction D2, there is an offset between the center of the first light-transmitting area T151 of the first light-adjusting layer LAL1 and the center of the second light-transmitting area T251 of the second light-adjusting layer LAL2.

In some embodiments, in the first direction D1, there may be a first distance d1 between the first edge E1 of the first light-transmitting area T151 of the first light-adjusting layer LAL1 and the first reference position RP1. In some embodiments, in the first direction D1, there may be a second distance d2 between the second edge E2 of the second light-transmitting area T251 of the second light-adjusting layer LAL2 and the first reference position RP1. In some embodiments, the first distance d1 may be greater than the second distance d2. For example, the first offset OS1 may be the difference between the first distance d1 and the second distance d2. In some embodiments, the first offset OS1 may be in the range of 0.05 um-100 μm, for example, it may be in the range of 0.1 um-10 um. For example, the first offset OS1 may be 0.1 um, 0.25 um, 0.5 μm, 0.75 um, 1 μm, 2 um, 3 μm, 4 um, 5 μm, 6 um, 7 μm, 8 um, 9 μm, 10 um, or any value or any range of values between the aforementioned values, but the present disclosure is not limited thereto.

As shown in FIG. 3, in some embodiments, in the first direction D1, the first light-transmitting area T151 may have a first width 151a, and the second light-transmitting area T251 may have a second width 251a. The first width 151a of the first light-transmitting area T151 may be equal to the second width 251a of the second light-transmitting area T251. According to other embodiments, the first width 151a of the first light-transmitting area T151 may be greater than or smaller than the second width 251a of the second light-transmitting area T251. Through the design of the first offset OS1 between the first edge E1 of the first light-transmitting area T151 of the first light-adjusting layer LAL1 and the second edge E2 of the second light-transmitting area T251 of the second light-adjusting layer LAL2, the light passing through the first light-transmitting area T151 and the second light-transmitting area T251 will be offset (shifted). As shown in FIGS. 1 to 3, in the first direction D1, the second edge E2 is closer to the first reference position RP1 than the first edge E1, or the second edge E2 is closer to the first expected viewing angle position P1. Therefore, through the offset between the light-transmitting areas in the two light-adjusting layers (for example, the first offset OS1 between the first light-transmitting area T151 and the second light-transmitting area T251), the light passing through the first light-transmitting area T151 and the second light-transmitting area T251 will be shifted toward the first expected viewing angle position P1. That is, in the first direction D1, the emitted light L1′ passing through the first light-transmitting area T151 and the second light-transmitting area T251 may be shifted toward the first expected viewing angle position P1. That is, in the structure of FIG. 1, since the first expected viewing angle position P1 is on the right side of the first light-transmitting area T151 and the second light-transmitting area T251, the emitted light L1′ passing through the first light-transmitting area T151 and the second light-transmitting area T251 may be shifted to the right.

According to some embodiments, as shown in FIG. 1, when the first reference line (the first reference position RP1) is the second direction D2, and in the same column arranged along the second direction D2, the light-transmitting areas in two light-adjusting layers may have the same amount of the offset in the first direction D1. In detail, in the first column C1, in the first direction D1, there is the first offset OS1 between the first light-transmitting area T151 and the second light-transmitting area T251, and there is also the same first offset OS1 between the light-transmitting area T111 and the light-transmitting area T211.

As shown in FIG. 3, in some embodiments, in the light-transmitting area of the last row Rm, in the first direction D1, the first light-adjusting layer LAL1 may have a third light-transmitting area T155, and the second light-adjusting layer LAL2 may have a fourth light-transmitting area T255. In some embodiments, the third light-transmitting area T155 of the first light-adjusting layer LAL1 may partially overlap the fourth light-transmitting area T255 of the second light-adjusting layer LAL2 and partially not overlap the fourth light-transmitting area T255 of the second light-adjusting layer LAL2. According to some embodiments, the third light-transmitting area T155 may be the light-transmitting area of the n^{th} column (for example, the last column Cn), and the third light-transmitting area T155 may be the light-transmitting area closest to the second side 10E2 of the substrate 10. Compared with the third light-transmitting area T155, the light-shielding area S13 (also referred as the third light-shielding area) is closer to the second side 10E2, and the edge of the third light-shielding area S13 may be aligned with the second side 10E2. According to some embodiments, the fourth light-transmitting area T255 may be the light-transmitting area of the n^{th} column (for example, the last column Cn), and the fourth light-transmitting area T255 may be the light-transmitting area closest to the second side 10E2 of the substrate 10. Compared with the fourth light-transmitting area T255, the light-shielding area S14 (also referred as the fourth light-shielding area) is closer to the second side 10E2, and the edge of the fourth light-shielding area S14 may be aligned with the second side 10E2. As shown in FIG. 2, in the first direction D1, the width of the fourth light-shielding area S14 may be greater than the width of the third light-shielding area S13.

As shown in FIG. 3, in some embodiments, in the first direction D1, the third light-transmitting area T155 may have a third edge E3 away from the first reference position RP1, and the fourth light-transmitting area T255 may have a fourth edge E4 away from the first reference position RP1. According to some embodiments, in the first direction D1, there may be a second offset OS2 between the third edge E3 of the third light-transmitting area T155 of the first light-adjusting layer LAL1 and the fourth edge E4 of the fourth light-transmitting area T255 of the second light-adjusting layer LAL2. The second offset OS2 may be greater than 0. In some embodiments, the second offset OS2 may be in the range of 0.05 um-100 μm. For the second offset OS2, please refer to the relevant description of the first offset OS1, which will not be described here.

As shown in FIG. 3, in some embodiments, in the first direction D1, there may be a third distance d3 between the third edge E3 of the third light-transmitting area T155 of the first light-adjusting layer LAL1 and the first reference position RP1. In some embodiments, in the first direction D1, there may be a fourth distance d4 between the fourth edge E4 of the fourth light-transmitting area T255 of the second light-adjusting layer LAL2 and the first reference position RP1. In some embodiments, the third distance d3 may be greater than the fourth distance d4. For example, the second offset OS2 may be the difference between the third distance d3 and the fourth distance d4. In some embodiments, the second offset OS2 and the first offset OS1 may be the same or different.

Similarly, through the design of the second offset OS2 between the third edge E3 of the third light-transmitting area T155 of the first light-adjusting layer LAL1 and the fourth edge E4 of the fourth light-transmitting area T255 of the second light-adjusting layer LAL2, the light passing through the third light-transmitting area T155 and the fourth light-transmitting area T255 will be offset. As shown in FIGS. 1 to 3, in the first direction D1, the fourth edge E4 is closer to the first reference position RP1 than the third edge E3, or the fourth edge E4 is closer to the first expected viewing angle position P1. Therefore, in the first direction D1, the emitted light L1′ passing through the third light-transmitting area T155 and the fourth light-transmitting area T255 may be shifted toward the first expected viewing angle position P1. In the structure of FIG. 1, since the first expected viewing angle position P1 is on the left side of the third light-transmitting area T155 and the fourth light-transmitting area T255, the emitted light L1′ passing through the third light-transmitting area T155 and the fourth light-transmitting area T255 may be shifted to the left.

As shown in FIGS. 1 and 3, in some embodiments, in the light-transmitting area of the last row Rm, the first light-adjusting layer LAL1 may have a light-transmitting area T153 (also referred as a fifth light-transmitting area), and the second light-adjusting layer LAL2 may have a light-transmitting area T253 (also referred as a sixth light-transmitting area). In the first direction D1, the fifth light-transmitting area T153 of the first light-adjusting layer LAL1 may be located between the first light-transmitting area T151 and the third light-transmitting area T155, and the sixth light-transmitting area T253 of the second light-adjusting layer LAL2 may be located between the second light-transmitting area T251 and the fourth light-transmitting area T255. Compared with the light-transmitting areas of the first row R1, the fifth light-transmitting area T153 and the sixth light-transmitting area T253 are further away from the fourth side 10E4 of the substrate 10. The fifth light-transmitting area T153 and the sixth light-transmitting area T253 may overlap the first reference position RP1 (the first reference line). In some embodiments, the fifth light-transmitting area T153 of the first light-adjusting layer LAL1 may partially overlap the sixth light-transmitting area T253 of the second light-adjusting layer LAL2 and partially not overlap the sixth light-transmitting area T253 of the second light-adjusting layer LAL2.

In some embodiments, the fifth light-transmitting area T153 of the first light-adjusting layer LAL1 and the sixth light-transmitting area T253 of the second light-adjusting layer LAL2 are aligned in the first direction D1. According to some embodiments, in the first direction D1, the center of the fifth light-transmitting area T153 of the first light-adjusting layer LAL1 may be aligned with the center of the sixth light-transmitting area T253 of the second light-adjusting layer LAL2. Accordingly, in some embodiments, in the first direction D1, the fifth light-transmitting area T153 of the first light-adjusting layer LAL1 and the sixth light-transmitting area T253 of the second light-adjusting layer LAL2 may substantially have no offset. That is, in the first direction D1, the offset between the fifth light-transmitting area T153 and the sixth light-transmitting area T253 may be 0. In the first direction D1, the width of the fifth light-transmitting area T153 may be equal to, smaller than, or greater than the width of the sixth light-transmitting area T253, but the present disclosure is not limited thereto.

As shown in FIG. 1, in some embodiments, the first light-adjusting layer LAL1 may have a light-transmitting area T113 (also referred as a seventh light-transmitting area) disposed in the light-transmitting area of the first row R1 (wherein the light-transmitting area T113 is one or more of the light-transmitting areas of the first row R1). In some embodiments, the second light-adjusting layer LAL2 may have a light-transmitting area T213 (also referred as an eighth light-transmitting area) disposed in the light-transmitting area of the first row R1 (wherein the light-transmitting area T213 is one or more of the light-transmitting areas the first row R1). The first reference position RP1 may overlap the seventh light-transmitting area T113 in the first light-adjusting layer LAL1 and the eighth light-transmitting area T213 in the second light-adjusting layer LAL2. The second reference position RP2 may overlap the seventh light-transmitting area T113 in the first light-adjusting layer LAL1 and the eighth light-transmitting area T213 in the second light-adjusting layer LAL2. In some embodiments, at the first expected viewing angle position P1, the seventh light-transmitting area T113 of the first light-adjusting layer LAL1 may completely overlap the eighth light-transmitting area T213 of the second light-adjusting layer LAL2. In some embodiments, the seventh light-transmitting area T113 of the first light-adjusting layer LAL1 and the eighth light-transmitting area T213 of the second light-adjusting layer LAL2 are aligned in the first direction D1 and the second direction D2. In other words, in the first direction D1 and the second direction D2, there is substantially no offset between the seventh light-transmitting area T113 and the eighth light-transmitting area T213 or the offset may be 0. In other embodiments, the first expected viewing angle position P1 may correspond to one or more light-transmitting areas among the m×n light-transmitting areas. Therefore, one or more light-transmitting areas in the first light-adjusting layer LAL1 may completely overlap the corresponding one or more light-transmitting areas in the second light-adjusting layer LAL2. In some embodiments, in the first direction D1, the width of the seventh light-transmitting area T113 may be equal to, smaller than, or greater than the width of the eighth light-transmitting area T213, but the present disclosure is not limited thereto. In some embodiments, in the second direction D2, the length of the seventh light-transmitting area T113 may be equal to, smaller than, or greater than the length of the eighth light-transmitting area T213, but the present disclosure is not limited thereto.

As shown in FIG. 3, in some embodiments, in the light-transmitting areas of the last row Rm, the first light-adjusting layer LAL1 may have a light-transmitting area T152 (also referred as a ninth light-transmitting area), and the second light-adjusting layer LAL2 may have a light-transmitting area T252 (also referred as a tenth light-transmitting area). In the first light-adjusting layer LAL1, in the first direction D1, the ninth light-transmitting area T152 may be disposed adjacent to the first light-transmitting area T151. In the second light-adjusting layer LAL2, in the first direction D1, the tenth light-transmitting area T252 may be disposed adjacent to the second light-transmitting area T251. In some embodiments, the ninth light-transmitting area T152 of the first light-adjusting layer LAL1 may partially overlap the tenth light-transmitting area T252 of the second light-adjusting layer LAL2 and may partially not overlap the tenth light-transmitting area T252 of the second light-adjusting layer LAL2. In some embodiments, in the first direction D1, the ninth light-transmitting area T152 of the first light-adjusting layer LAL1 may have a seventh edge E7 away from the first reference position RP1, and the light-transmitting area T252 of the second light-adjusting layer LAL2 may have an eighth edge E8 away from the first reference position RP1. In some embodiments, in the first direction D1, there may be a fourth offset OS4 between the seventh edge E7 of the ninth light-transmitting area T152 of the first light-adjusting layer LAL1 and the eighth edge E8 of the tenth light-transmitting area T252 of the second light-adjusting layer LAL2. The fourth offset OS4 may be greater than 0. In some embodiments, the fourth offset OS4 may be in the range of 0.05 um-100 μm. For the fourth offset OS4, please refer to the relevant description of the first offset OS1, which will not be described here. In some embodiments, the first offset OS1 may be greater than the fourth offset OS4.

In some embodiments, in the first direction D1, there may be a seventh distance d7 between the seventh edge E7 of the ninth light-transmitting area T152 of the first light-adjusting layer LAL1 and the first reference position RP1. In some embodiments, in the first direction D1, there may be an eighth distance d8 between the eighth edge E8 of the tenth light-transmitting area T252 of the second light-adjusting layer LAL2 and the first reference position RP1. In some embodiments, the seventh distance d7 may be greater than the eighth distance d8. The first light L1 passing through the ninth light-transmitting area T152 and the tenth light-transmitting area T252 emits toward the first expected viewing angle position P1. For example, the fourth offset OS4 may be the difference between the seventh distance d7 and the eighth distance d8.

In some embodiments, as shown in FIGS. 1 to 3, the offset between the two light-transmitting areas may be designed to gradually decrease closer to the first reference position RP1. In detail, in the first light-adjusting layer LAL1, the ninth light-transmitting area T152 is closer to the first reference position RP1 than the first light-transmitting area T151. In the second light-adjusting layer LAL2, the tenth light-transmitting area T252 is closer to the first reference position RP1 than the second light-transmitting area T251. Therefore, in the first direction D1, the fourth offset OS4 between the ninth light-transmitting area T152 and the tenth light-transmitting area T252 may be designed to be smaller than the first offset OS1 between the first light-transmitting area T151 and the second light-transmitting area T251.

In FIG. 2, although no light-transmitting area is shown between the ninth light-transmitting area T152 and the fifth light-transmitting area T153, and no light-transmitting area is shown between the tenth light-transmitting area T252 and the sixth light-transmitting area T253, the offset (not shown) between a first additional light-transmitting area (in the first direction D1, between the ninth light-transmitting area T152 and the fifth light-transmitting area T153, not shown) in the first light adjustment layer LAL1 and a second additional light-transmitting area (in the first direction D1, between the tenth light-transmitting area T252 and the sixth light-transmitting area T253, not shown) in the second light adjustment layer LAL2 may be designed to be greater than 0 and smaller than the fourth offset OS4. In other words, in the first light-adjusting layer LAL1, the first additional light-transmitting area (not shown) may be disposed between the ninth light-transmitting area T152 and the fifth light-transmitting area T153, and in the second light-adjusting layer LAL2, the second additional light-transmitting area (not shown) may be disposed between the tenth light-transmitting area T252 and the sixth light-transmitting area T253, and the offset between the first additional light-transmitting area and the second additional light-transmitting area is greater than 0 and smaller than the fourth offset OS4. According to some embodiments, the further away from the first reference position RP1, the greater the offset of the light-transmitting areas (for example, increasing the offset gradually or stepwise), and the closer to the first reference position RP1, the smaller the offset of the light-transmitting areas. Accordingly, the degree of the offset of the emitted light L1′ may be adjusted by the amount of the offset of the light-transmitting areas.

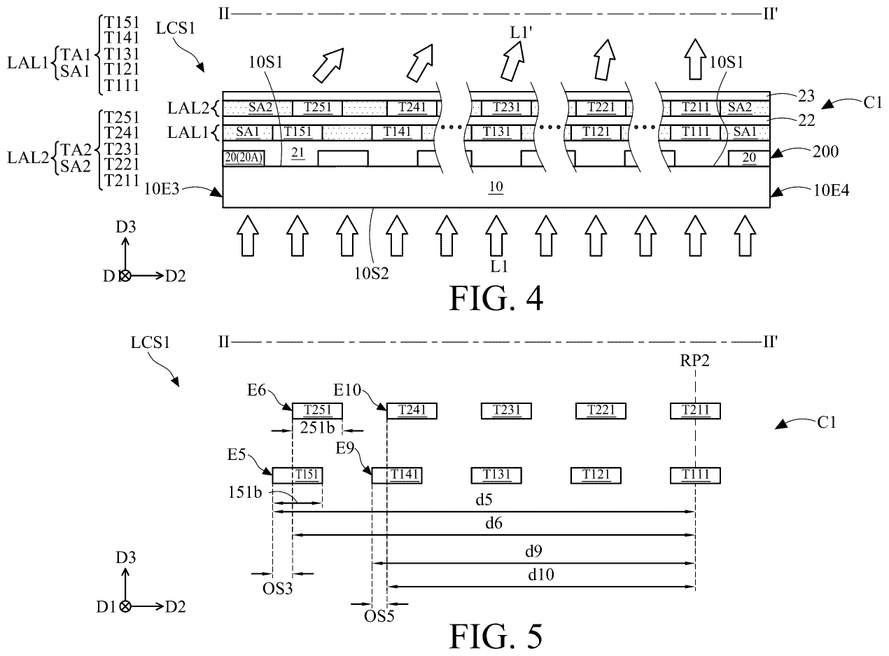

Referring to FIG. 4, which is a schematic cross-sectional view of the light-controlling structure LCS1 according to some embodiments of the present disclosure. FIG. 4 shows a schematic cross-sectional view taken along line segment II-II′ shown in FIG. 1. Referring to FIG. 5, which is a schematic cross-sectional view of the light-transmitting areas of the light-controlling structure LCS1 according to some embodiments of the present disclosure. FIG. 5 is a further simplified diagram of FIG. 4, showing only the light-transmitting areas. As shown in FIG. 5, in the second direction D2, the first light-transmitting area T151 of the first light-adjusting layer LAL1 may have a fifth edge E5 away from the second reference position RP2, and the second light-transmitting area T251 of the second light-adjusting layer LAL2 may have a sixth edge E6 away from the second reference position RP2. In some embodiments, in the second direction D2, there may be a third offset OS3 between the fifth edge E5 of the first light-transmitting area T151 of the first light-adjusting layer LAL1 and the sixth edge E6 of the second light-transmitting area T251 of the second light-adjusting layer LAL2. The third offset OS3 may be greater than 0. For example, the third offset OS3 may be in the range of 0.05 um-100 μm. For other ranges, please refer to the relevant description of the first offset OS1, which will not be described here.

As shown in FIGS. 1 and 5, in some embodiments, in the light-transmitting areas of the first column C1, the first light-adjusting layer LAL1 may have a light-transmitting area T141 (also referred as an eleventh light-transmitting area), and the second light-adjusting layer LAL2 may have a light-transmitting area T241 (also referred as a twelfth light-transmitting area). In some embodiments, in the second direction D2, the eleventh light-transmitting area T141 may be disposed adjacent to the first light-transmitting area T151, and the twelfth light-transmitting area T241 may be disposed adjacent to the second light-transmitting area T251. In some embodiments, the eleventh light-transmitting area T141 of the first light-adjusting layer LAL1 may partially overlap the twelfth light-transmitting area T241 of the second light-adjusting layer LAL2 and may partially not overlap the twelfth light-transmitting area T241 of the second light-adjusting layer LAL2. In some embodiments, in the second direction D2, the eleventh light-transmitting area T141 of the first light-adjusting layer LAL1 may have a ninth edge E9 away from the second reference position RP2, and the twelve light-transmitting areas T241 of the second light-adjusting layer LAL2 may have a tenth edge E10 away from the second reference position RP2. In some embodiments, there may be a fifth offset OS5 between the ninth edge E9 and the tenth edge E10 in the second direction D2. The fifth offset OS5 may be greater than 0. The fifth offset OS5 may be in a range of 0.05 um-100 μm. For the fifth offset OS5, please refer to the relevant description of the first offset OS1, which will not be described here. In some embodiments, the third offset OS3 may be greater than the fifth offset OS5.

According to some embodiments, as shown in FIG. 1, the seventh light-transmitting area T113 in the first light-adjusting layer LAL1 and the eighth light-transmitting area T213 in the second light-adjusting layer LAL2 are disposed at the first expected viewing angle position P1. As mentioned above, the first light-adjusting layer LAL1 has the ninth light-transmitting area T152, and the second light-adjusting layer LAL2 has the tenth light-transmitting area T252. In the first direction D1, there may be the fourth offset OS4 between the ninth light-transmitting area T152 and the tenth light-transmitting area T252. At the first expected viewing angle position P1, the seventh light-transmitting area T113 and the eighth light-transmitting area T213 may be designed such that, in the first direction D1, the offset between the seventh light-transmitting area T113 and the eighth light-transmitting area T213 is 0 or smaller than the fourth offset OS4. In this way, in the first direction D1, the emitted light L′ may be shifted toward the first expected viewing angle position P1.

According to some embodiments, as shown in FIG. 1, as mentioned above, the first light-adjusting layer LAL1 has the eleventh light-transmitting area T141, and the second light-adjusting layer LAL2 has the twelfth light-transmitting area T241. In the second direction D2, there is the fifth offset OS5 between the eleventh light-transmitting area T141 and the twelfth light-transmitting area T241. At the first expected viewing angle position P1, the seventh light-transmitting area T113 and the eighth light-transmitting area T213 may be designed such that, in the second direction D2, the offset between the seventh light-transmitting area T113 and the eighth light-transmitting area T213 is 0 or smaller than the fifth offset OS5. In this way, in the second direction D2, the emitted light L1′ may be shifted toward the first expected viewing angle position P1.

According to some embodiments, as shown in FIG. 1, the first expected viewing angle position P1 may be an area. The seventh light-transmitting area T113 in the first light-adjusting layer LAL1 and the eighth light-transmitting area T213 in the second light-adjusting layer LAL2 are disposed within the first expected viewing angle position P1. In detail, a plurality of seventh light-transmitting areas T113 and a plurality of eighth light-transmitting areas T213 may be disposed within the first expected viewing angle position P1. The number of the seventh light-transmitting areas T113 and the number of the eighth light-transmitting areas T213 may be the same or different. When the number of the seventh light-transmitting areas T113 is the same as the number of the eighth light-transmitting areas T213, taking the number of the seventh light-transmitting areas T113 as an example, although not shown in the drawings, within the first expected viewing angle position P1, the seventh light-transmitting areas T113 arranged in a×b matrix may be provided. That is, a rows and b columns are provided. In detail, b seventh light-transmitting areas T113 are provided in the first direction D1, and a seventh light-transmitting areas T113 are provided in the second direction D2, so as to form a×b matrix of seventh light-transmitting areas T113 in the first light-adjusting layer LAL1. Similarly, although not shown in the drawings, the eighth light-transmitting areas T213 arranged in a×b matrix may be provided in the second light-adjusting layer LAL2 in the first expected viewing angle position P1. a and b may independently be a positive integer ranging from 1 to 100, for example, a positive integer ranging from 2 to 70, a positive integer ranging from 3 to 50, a positive integer ranging from 3 to 30, and a positive integer ranging from 5 to 15. a and b may be equal or unequal, but the present disclosure is not limited thereto. a is smaller than m, and b is smaller than the n.

As shown in FIGS. 1, 4, and 5, the offset between the two light-transmitting areas may be designed to gradually decrease closer to the second reference position RP2. In detail, in the first light-adjusting layer LAL1, the eleventh light-transmitting area T141 is closer to the second reference position RP2 than the first light-transmitting area T151. In the second light-adjusting layer LAL1, the twelfth light-transmitting area T241 is closer to the second reference position RP2 than the second light-transmitting area T251. Therefore, in the second direction D2, the fifth offset OS5 between the eleventh light-transmitting area T141 and the twelfth light-transmitting area T241 may be designed to be smaller than the third offset OS3 between the first light-transmitting area T151 and the second light-transmitting area T251.

In FIG. 4, although no light-transmitting area is shown between the eleventh light-transmitting area T141 and the light-transmitting area T131, and no light-transmitting area is shown between the twelfth light-transmitting area T241 and the light-transmitting area T231, the offset (not shown) between a third additional light-transmitting area (in the second direction D1, between the eleventh light-transmitting area T141 and the light-transmitting area T131, not shown) in the first light adjustment layer LAL1 and a fourth additional light-transmitting area (in the second direction D2, between the twelfth light-transmitting area T241 and the light-transmitting area T231, not shown) in the second light adjustment layer LAL2 may be designed to be greater than 0 and smaller than the fifth offset OS5. In other words, in the first light-adjusting layer LAL1, the third additional light-transmitting area (not shown) may be disposed between the eleventh light-transmitting area T141 and the light-transmitting area T131, and in the second light-adjusting layer LAL2, the fourth additional light-transmitting area (not shown) may be disposed between the twelfth light-transmitting area T241 and the light-transmitting area T231, and the offset between the third additional light-transmitting area and the fourth additional light-transmitting area is greater than 0 and smaller than the fifth offset OS5. According to some embodiments, the further away from the second reference position RP2, the greater the offset of the light-transmitting areas (for example, increasing the offset gradually or stepwise), and the closer to the second reference position RP2, the smaller the offset of the light-transmitting areas. Accordingly, the degree of the offset of the emitted light L1′ may be adjusted by the amount of the offset of the light-transmitting areas.

In this way, as shown in FIGS. 1, 4, and 5, in the second direction D2, through the offset between the light-transmitting areas in at least two light-adjusting layers (for example, the third offset OS3 between the first light-transmitting area T151 and the second light-transmitting area T251), the light passing through the light-transmitting areas in the first light-adjusting layer LAL1 and the second light-adjusting layer LAL2 may be shifted toward the first expected viewing angle position P1. That is, in the structure of FIG. 1, the emitted light L1′ passing through the light-transmitting areas in the first light-adjusting layer LAL1 and the second light-adjusting layer LAL2 may be shifted upward.

In some embodiments, as shown in FIG. 5, in the second direction D2, there may be a fifth distance d5 between the fifth edge E5 of the first light-transmitting area T151 of the first light-adjusting layer LAL1 and the second reference position RP2. In some embodiments, in the second direction D2, there may be a sixth distance d6 between the sixth edge E6 of the second light-transmitting area T251 of the second light-adjusting layer LAL2 and the second reference position RP2. In some embodiments, the fifth distance d5 may be greater than the sixth distance d6. For example, the third offset OS3 may be the difference between the fifth distance d5 and the sixth distance d6. In some embodiments, in the second direction D2, the first light-transmitting area T151 may have a first length 151b, and the second light-transmitting area T251 may have a second length 251b. The first length 151b of the first light-transmitting area T151 may be equal to the second length 251b of the second light-transmitting area T251. According to other embodiments, the first length 151b of the first light-transmitting area T151 may be greater than or smaller than the second length 251b of the second light-transmitting area T251. In some embodiments, in the second direction D2, there may be a ninth distance d9 between the ninth edge E9 of the eleventh light-transmitting area T141 of the first light-adjusting layer LAL1 and the second reference position RP2. In some embodiments, in the second direction D2, there may be a tenth distance d10 between the tenth edge E10 of the twelfth light-transmitting area T241 of the second light-adjusting layer LAL2 and the second reference position RP2. In some embodiments, the ninth distance d9 may be greater than the tenth distance d10. For example, the fifth offset OS5 may be the difference between the ninth distance d9 and the tenth distance d10.

According to some embodiments, as shown in FIG. 1, when the second reference line (the second reference position RP2) is the first direction D1, and in the same row arranged along the first direction D1, the light-transmitting areas in two light-adjusting layers may have the same amount of the offset in the second direction D2. In detail, in the last row Rm, in the second direction D2, there is the third offset OS3 between the first light-transmitting area T151 and the second light-transmitting area T251, and there is also the same third offset OS3 between the ninth light-transmitting area T152 and the tenth light-transmitting area T252.

As mentioned above, as shown in FIGS. 1 to 5, in some embodiments, through the design of the offset between the light-transmitting areas in at least two light-adjusting layers, the emitted light may be shifted toward the expected viewing angle position. In this way, greater brightness may be obtained at the expected viewing angle position.

FIG. 6 is a schematic cross-sectional view of a light-controlling structure LCS2 according to some embodiments of the present disclosure. The light-controlling structure LCS2 may include a substrate 10 and a plurality of light-adjusting layers (for example, a first light-adjusting layer LAL1, a second light-adjusting layer LAL2, a third light-adjusting layer LAL3 . . . and a U^{th} light-adjusting layer LALU) provided on the substrate 10). The number of light-adjusting layers may be at least two layers, that is, two or more layers. As shown in FIG. 6, in some embodiments, the light-controlling structure LCS2 may further include a third light-adjusting layer LAL3, and the third light-adjusting layer LAL3 may be disposed on the second light-adjusting layer LAL2. In some embodiments, the light-controlling structure LCS2 may further include the third light-adjusting layer LAL3 to U^{th} light-adjusting layer LALU. In some embodiments, U may be a positive integer greater than 3. For example, U may be in a range of 3-100, 3-50, or 5-25, but the present disclosure is not limited thereto. According to some embodiments, a light-transmitting layer 22 may be disposed between two light-adjusting layers. For example, the light-transmitting layer 22 may be disposed between the first light-adjusting layer LAL1 and the second light-adjusting layer LAL2. The light-transmitting layer 23 may be disposed on an uppermost light-adjusting layer, that is, on the U^{th} light-adjusting layer LALU.

In some embodiments, in the third direction D3, a total thickness of layers disposed on the substrate 10 in the light-controlling structure LCS2 may be in a range of 10 um-1000 μm, for example, 10 um-100 μm. In other words, the total thickness of layers in the light-controlling structure LCS2 except the substrate 10 may be 10 um-1000 μm. For example, the total thickness may be 10 μm, 20 μm, 30 μm, 40 um, 50 μm, 60 μm, 70 μm, 80 um, 90 μm, 100 μm, 500 μm, 800 μm, 1000 μm, or any value or any range of values between the aforementioned values, but the present disclosure is not limited thereto.

In some embodiments, in the first direction D1, the offset between the light-transmitting area in the u^{th} light-adjusting layer and the corresponding light-transmitting area in the (u−1)^{th} light-adjusting layer may be in a range of 0.05 um-100 um, other suitable ranges may refer to the aforementioned first offset OS1. In some embodiments, in the second direction D2, the offset between the light-transmitting area in the u^{th} light-adjusting layer and the corresponding light-transmitting area in the (u−1)^{th} light-adjusting layer may be in a range of 0.05 um-100 um, other suitable ranges may refer to the aforementioned third offset OS3. In the structure of FIG. 6, for descriptions of various components such as the substrate, the reflective layer, the light-transmitting layer, the light-adjusting layer, and the like, please refer to the above-mentioned relevant description and will not be repeated here.

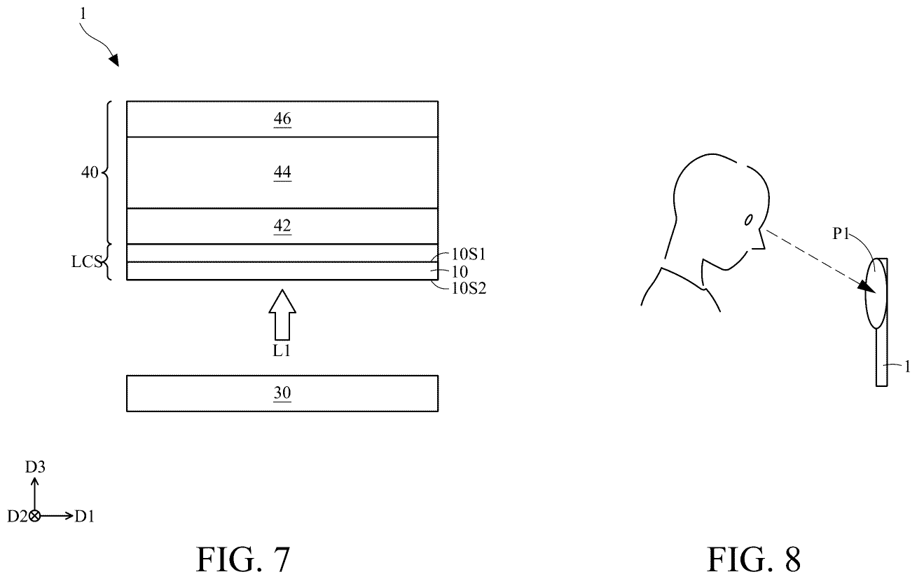

Referring to FIG. 7, which is a schematic cross-sectional view of an electronic device 1 according to some embodiments of the present disclosure. As shown in FIG. 7, in some embodiments, the electronic device 1 may include a light-controlling structure LCS. For example, the light-controlling structure LCS may be one or more of the aforementioned light-controlling structures LCS1 and LCS2 and the following LCS3 to LCS5. To simplify the description, FIG. 7 does not show other components in the light-controlling structure LCS except the substrate 10, for example, the light-adjusting layer is not shown.

In some embodiments, as shown in FIG. 7, the electronic device 1 may further include a light source. In some embodiments, the light source may include a backlight structure 30 for providing the first light L1. In some embodiments, the substrate 10 may include a second surface 10S2. In the third direction D3, the second surface 10S2 may be opposite to the first surface 10S1. In some embodiments, the second surface 10S2 of the substrate 10 is closer to the light source than the first surface 10S1 of the substrate 10, for example, closer to the backlight structure 30. In some embodiments, the second surface 10S2 of the substrate 10 may be used to receive the first light L1.

As shown in FIG. 7, in some embodiments, the electronic device 1 may further include a display panel 40. In some embodiments, the light-controlling structure LCS may be disposed between the light source and the display panel 40. In some embodiments, the display panel 40 may include a liquid-crystal display panel, a light-emitting diode display panel, the like, or a combination thereof, but the present disclosure is not limited thereto. The light-emitting diode display panel may include an inorganic light-emitting diode display panel, an organic light-emitting diode display panel, a mini light-emitting diode display panel, a micro light-emitting diode display panel, a quantum dot light-emitting diode display panel, the like, or a combination thereof, but the present disclosure is not limited thereto. In some embodiments, the display panel 40 may include a lower plate 42, an upper plate 46, and a display layer 44 disposed between the lower plate 42 and the upper plate 46. The display layer 44 may be a liquid-crystal layer. In some embodiments, the material of the lower plate 42 and/or the upper plate 46 and the material of the substrate 10 may be the same or different. In some embodiments, the lower plate 42 of the display panel 40 may be disposed on the light-controlling structure LCS. That is, the light-controlling structure LCS may be disposed between the lower plate 42 and the light source.

Referring to FIG. 8, which is a schematic usage diagram of the electronic device 1 according to some embodiments of the present disclosure. As shown in FIG. 8, in some embodiments, when the user observes the electronic device 1 including the light-controlling structure LCS, and the user views toward the first expected viewing angle position P1, the emitted light may have maximum brightness. In some embodiments, the electronic device 1 may be applied to vehicle electronic devices, such as electronic instrument panels, electronic center consoles, and the like, but the present disclosure is not limited thereto.

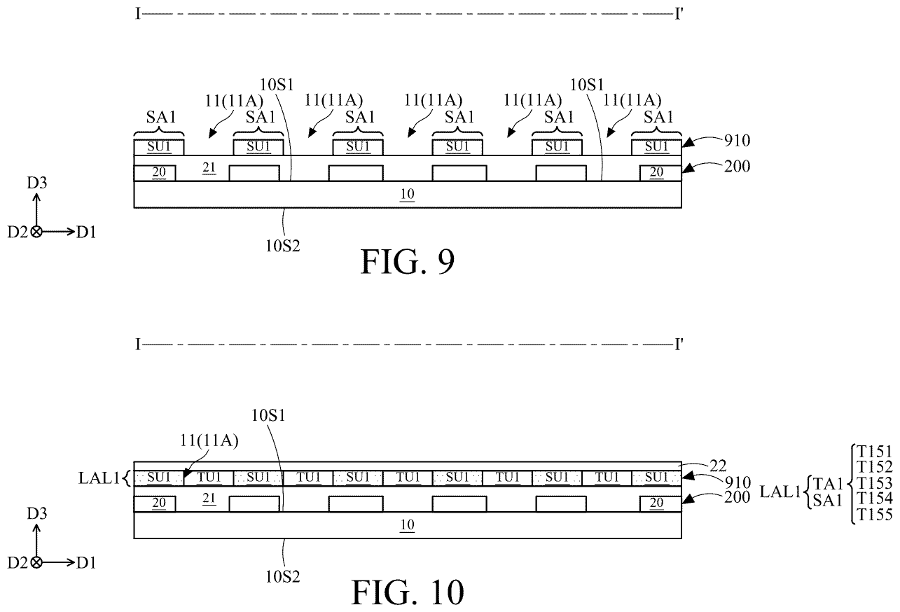

FIGS. 9 to 11 are schematic cross-sectional views of various stages of a manufacturing process of a light-controlling structure according to some embodiments of the present disclosure. For ease of explanation, the light-controlling structure LCS1 taken along the line segment I-I′ in FIG. 1 is used as an example for description.

As shown in FIG. 9, in some embodiments, a substrate 10 is provided. In some embodiments, the reflective layer 200 may be disposed on the substrate 10. The reflective layer 200 may include a plurality of reflective units 20. For detailed descriptions, please refer to the above description related to FIG. 2, which will not be described here. In some embodiments, the reflective layer 200 may include white reflective material, white photoresist material, metal, metal oxide, the like, or a combination thereof, but the present disclosure is not limited thereto. For example, the metal may include silver (Ag), aluminum (Al), copper (Cu), chromium (Cr), titanium (Ti), alloys thereof, the like, or a combination thereof, but the present disclosure is not limited thereto. In some embodiments, the reflectivity of the reflective layer 200 may be greater than 80%, 85%, 90%, 95%, 99%, 99.9%, 99.99%, or any value or any range of values between the aforementioned values, but the present disclosure is not limited thereto.

As shown in FIG. 9, in some embodiments, the light-transmitting layer 21 may be disposed on the reflective layer 200 and the first surface 10S1 of the substrate 10. At least a portion of the light-transmitting layer 21 may be disposed within the opening of the reflective layer 200. In some embodiments, the light-transmitting layer 21 may include acrylic resin, polyimide, the like, or a combination thereof, but the present disclosure is not limited thereto. In some embodiments, the transmittance of the light-transmitting layer 21 may be greater than 80%, 85%, 90%, 95%, 99%, 99.9%, 99.99%, or any value or any range of values between the aforementioned values, but the present disclosure is not limited thereto. In some embodiments, the material and transmittance of the light-transmitting layer 22 or the light-transmitting layer 23 may refer to the above description of the light-transmitting layer 21, and will not be described here.

As shown in FIG. 9, in some embodiments, the first light-shielding layer 910 may be disposed on the light-transmitting layer 21, and the first light-shielding layer 910 may be patterned to have a plurality of first openings 11, and the first light-transmitting unit TU1 may be disposed inside the first opening 11 of the first light-shielding layer 910. The position of the first opening 11 is defined as the light-transmitting area TA1. That is, referring to FIGS. 2, 9, and 10 at the same time, taking one light-transmitting area T151 as an example, the first opening 11A defines the first light-transmitting area T151, and the first light-transmitting unit TU1 may be disposed in the first opening 11A. In some embodiments, the first opening 11 may correspond to the light-transmitting area TA1 (for example, the light-transmitting areas T151-T155). In some embodiments, the first light-shielding unit SU1 may include black resin, black photoresist material, black matrix, low-reflective metal, the like, or a combination thereof, but the present disclosure is not limited thereto. In some embodiments, the reflectivity of the first light-shielding unit SU1 may be smaller than 30%, 25%, 20%, 15%, 10%, 5%, 1%, or any value or any range of values between the aforementioned values, but the present disclosure is not limited thereto.

As shown in FIG. 10, in some embodiments, the first light-transmitting unit TU1 may be disposed in the light-transmitting area TA1 and disposed in the first opening 11. In some embodiments, the material of the first light-transmitting unit TU1 and the material of the light-transmitting layer 21 may be the same or different. Accordingly, the first light-adjusting layer LAL1 may include the first light-shielding unit SU1 and the first light-transmitting unit TU1. In detail, the first light-adjusting layer LAL1 may include a plurality of first light-shielding units SU1 and a plurality of first light-transmitting units TU1. In some embodiments, the reflective layer 200 may be disposed between the substrate 10 and the first light-adjusting layer LAL1.

As shown in FIG. 10, in some embodiments, the light-transmitting layer 22 may be disposed on the first light-adjusting layer LAL1. In some embodiments, the light-transmitting layer 22 may cover the first light-shielding unit SU1 and the first light-transmitting unit TU1. In some embodiments, the materials of the light-transmitting layer 22 and the first light-transmitting unit TU1 may be the same or different, and the light-transmitting layer 22 and the first light-transmitting unit TU1 may be formed in the same process or in different processes.

As shown in FIG. 11, in some embodiments, the second light-shielding layer 920 may be disposed on the light-transmitting layer 22 and the second light-shielding layer 920 may be patterned to have a plurality of second openings 12. The second light-transmitting unit TU2 may be disposed in the light-transmitting area TA2 and in the second opening 12. The position of the second opening 12 is defined as the light-transmitting area TA2. In some embodiments, the second light-shielding unit SU2 may be disposed on the light-transmitting layer 22. In some embodiments, the second light-shielding unit SU2 may be disposed in the light-shielding area SA2. In some embodiments, the second opening 12 may correspond to the subsequently formed light-transmitting area TA2 (for example, the light-transmitting areas T251-T255). In some embodiments, the materials of the second light-shielding unit SU2 and the first light-shielding unit SU1 may be the same or different. In some embodiments, the materials of the second light-transmitting unit TU2 and the first light-transmitting unit TU1 may be the same or different. In some embodiments, the light-transmitting layer 22 may be disposed between the first light-adjusting layer LAL1 and the second light-adjusting layer LAL2. In some embodiments, the light-transmitting layer 23 may be disposed on the second light-adjusting layer LAL2. The materials of the light-transmitting layer 23 and the second light-transmitting unit TU2 may be the same or different, and the light-transmitting layer 23 and the second light-transmitting unit TU2 may be formed in the same process or in different processes.

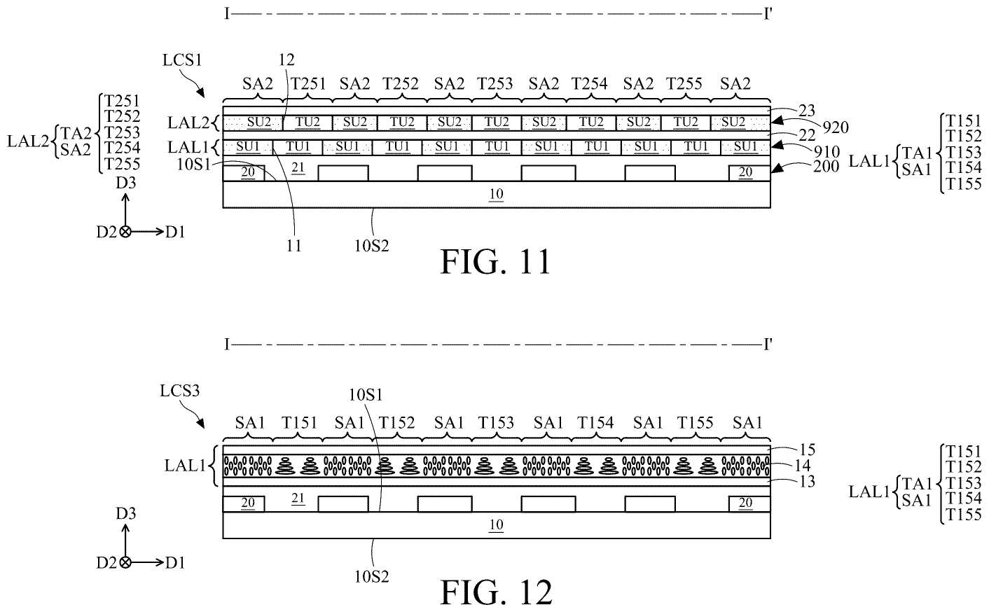

FIG. 12 is a schematic cross-sectional view of a stage of the manufacturing process of the light-controlling structure LCS3 according to some embodiments of the present disclosure. As shown in FIG. 12, in some embodiments, the first light-adjusting layer LAL1 may include a light-controlling medium 14. In some embodiments, the light-controlling medium 14 may generate the light-shielding area SA1 and the light-transmitting area TA1 by using an electrical energy. In some embodiments, the light-controlling medium 14 may include liquid-crystal molecules, electrophoretic capsules, the like, or a combination thereof, but the present disclosure is not limited thereto. In some embodiments, the first light-adjusting layer LAL1 may further include an upper electrode 15 and a lower electrode 13. In some embodiments, the lower electrode 13 may be disposed on the substrate 10, the light-controlling medium 14 may be disposed on the lower electrode 13, and the upper electrode 15 may be disposed on the light-controlling medium 14. The light-controlling medium 14 may be disposed between the lower electrode 13 and the upper electrode 15. In some embodiments, the upper electrode 13 and/or the lower electrode 15 may include a conductive material. For example, the conductive material may include metal, conductive metal oxide, transparent conductive material, the like, or a combination thereof, but the present disclosure is not limited thereto. The transparent conductive material may be, for example, indium tin oxide (ITO). Accordingly, the characteristics of the light-controlling medium 14 may be changed depending on whether a voltage is applied to the upper electrode 15 and the lower electrode 13. For example, the alignment direction of the liquid-crystal molecules may be changed, or the floating or sinking of the electrophoretic capsule may be changed. In other embodiments, one or more light-adjusting layers in the light-controlling structure LCS3 may include the light-controlling medium to generate light-shielding areas and light-transmitting areas in different light-adjusting layers by using the electrical energy. In other embodiments, as shown in FIG. 6, one of the plurality of light-adjusting layers may be the first light-adjusting layer LAL1 shown in FIG. 12, and the other one of the plurality of light-adjusting layers may be the second light-adjusting layer LAL2 shown in FIG. 11.

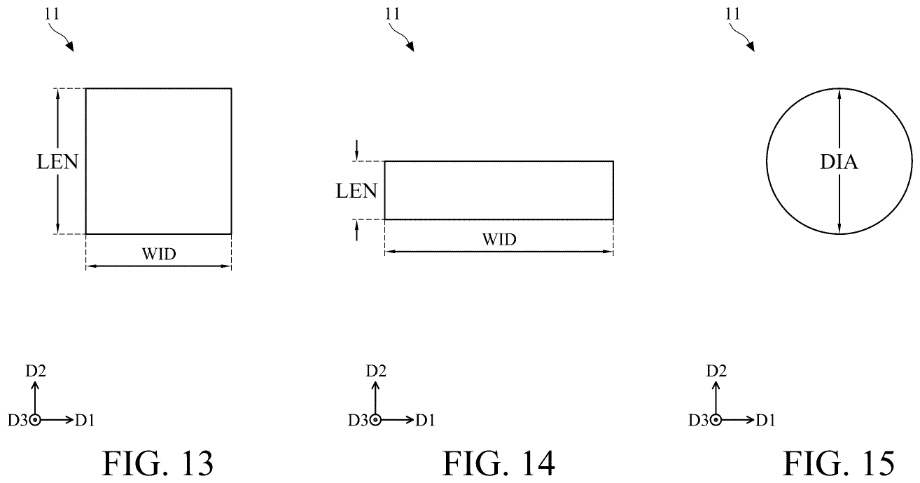

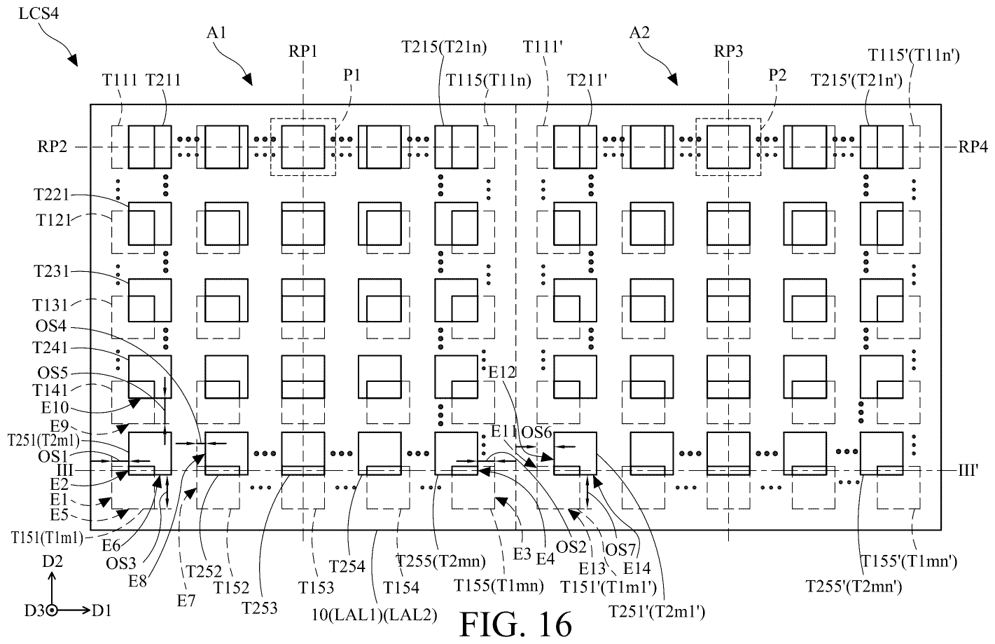

FIGS. 13 to 15 are schematic top views of the openings of the light-controlling structure according to some embodiments of the present disclosure, respectively. Please refer to FIGS. 11 and 13. In some embodiments, the first opening 11 of the first light-shielding layer 910 corresponds to the first light-transmitting area TA1. The first opening 11 of the first light-adjusting layer LAL1 (also referred as the first opening 11 of the first light-shielding layer 910) may have a width WID in the first direction D1, and may have a length LEN in the second direction D2. In some embodiments, the width WID may be any value in the range of 2 um-1000 μm, for example, the range of 10 um-850 μm, the range of 75 um-500 um, the range of 100 um-450 μm, the range of 100 um-400 μm, but the present disclosure is not limited thereto. In some embodiments, the length LEN may be any value in the range of 2 um-1000 μm, for example, in the range of 10 um-850 um, in the range of 75 um-500 um, in the range of 100 um-450 um, in the range of 100 um-400 μm, but the present disclosure is not limited thereto. In some embodiments, the first opening 11 may be rectangular, square, parallelogram, rhombus, or kite-shaped, but the present disclosure is not limited thereto. As shown in FIG. 14, in some embodiments, the width WID or the length LEN of the first opening 11 may be the same as the side length of the first light-adjusting layer LAL1.

As shown in FIG. 15, in some embodiments, the first opening 11 may have a diameter DIA. In some embodiments, the diameter DIA may be any value in the range of 2 um-1000 μm, for example, in the range of 10 um-850 um, in the range of 75 um-500 um, in the range of 100 um-450 um, in the range of 100 um-400 μm, but the present disclosure is not limited thereto. In some embodiments, the first opening 11 may be circular, oval, drop-shaped, or bullet-shaped, but the present disclosure is not limited thereto. In some embodiments, please refer to FIGS. 11 and 13, the second opening 12 of the second light-shielding layer 920 corresponds to the second light-transmitting area TA2. The second opening 12 in the second light-adjusting layer LAL2 may be referred as the second opening 12 of the second light-shielding layer 920. The second opening 12 and the first opening 11 may have different shapes or the same shape. The second opening 12 and the first opening 11 may have the same size or different sizes. In the case where the second opening 12 and the first opening 11 have the same shape (for example, both are rectangular), they may have the same size or different sizes.

Referring to FIG. 16, which is a schematic top view of a light-controlling structure LCS4 according to some embodiments of the present disclosure. As shown in FIG. 16, in some embodiments, the substrate 10 may have a first region A1 and a second region A2 adjacent to the first region A1, but the present disclosure is not limited thereto. In other embodiments, the substrate 10 may have a plurality of regions, and the plurality of regions may have corresponding expected viewing angle positions. As shown in FIG. 16, in some embodiments, two expected viewing angle positions (for example, the first expected viewing angle position P1 and a second expected viewing angle position P2) are used as an example, but the present disclosure is not limited thereto.

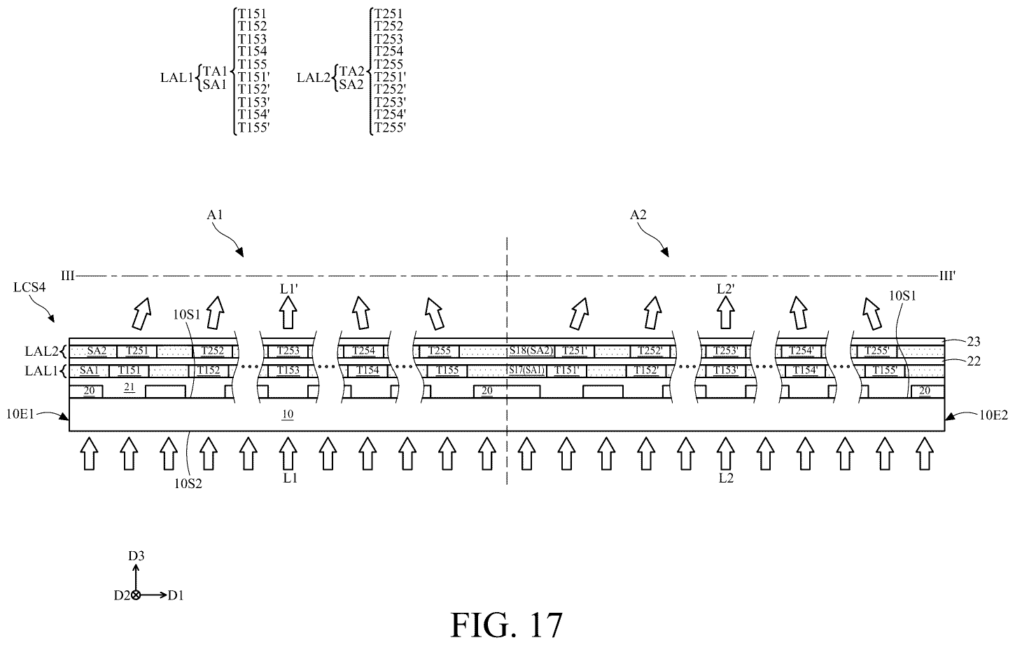

In some embodiments, as shown in FIGS. 16 and 17, the first light-adjusting layer LAL1 may be disposed on the substrate 10, and the first light-adjusting layer LAL1 may cross the first region A1 and the second region A2. The first light-adjusting layer LAL1 may have a plurality of light-transmitting areas T111-T1mn located in the first region A1 and a plurality of light-transmitting areas T111′-T1mn′ located in the second region A2. In detail, in the first light-adjusting layer LAL1, the plurality of light-transmitting areas may be arranged in an m×n matrix, with m rows and n columns. The direction of the row is along the first direction D1, and the direction of the column is along the second direction D2. Where, m may be a positive integer ranging from 5 to 10000, and n may be a positive integer ranging from 5 to 10000. For other relevant descriptions of m and n, please refer to the relevant descriptions related to the aforementioned FIG. 1. According to some embodiments, the first light-transmitting area T151 and the third light-transmitting area T155 of the first light-adjusting layer LAL1 are disposed in the first region A1, and the second light-transmitting area T251 and the fourth light-transmitting area T255 of the second light-adjusting layer LAL2 are disposed in the first region A1.

In some embodiments, the second light-adjusting layer LAL2 may be disposed on the substrate 10 and may be disposed on the first light-adjusting layer LAL1, and the second light-adjusting layer LAL2 may cross the first region A1 and the second region A2. The second light-adjusting layer LAL2 may have light-transmitting regions T211-T2mn located in the first region A1 and light-transmitting areas T211′-T2mn′ located in the second region A2. In some embodiments, the second expected viewing angle position P2 may correspond to one or more light-transmitting areas. In the second light-adjusting layer LAL2, the light-transmitting areas arranged in M×N matrix may also refer to the above description.

In some embodiments, the first expected viewing angle position P1 and the second expected viewing angle position P2 are aligned in the first direction D1 or the second direction D2. In other embodiments, the first expected viewing angle position P1 and the second expected viewing angle position P2 are not aligned in the first direction D1 and the second direction D2.

As mentioned above, for ease of explanation, FIG. 17 only shows five of the plurality of light-transmitting areas TA1 of the first light-adjusting layer LAL1 in the first region A1, and shows five of the plurality of light-transmitting areas TA1 of the first light-adjusting layer LAL1 in the second region A2. Similarly, FIG. 17 only shows five of the plurality of light-transmitting areas TA2 of the second light-adjusting layer LAL2 in the first region A1, and shows five of the plurality of light-transmitting areas TA2 of the second light-adjusting layer LAL2 in the second region A2. For other relevant descriptions of the light-transmitting areas arranged in the M×N matrix, please refer to the descriptions in the aforementioned FIGS. 1 and 2. Hereinafter, the light-transmitting area T151′ may be referred to as a thirteenth light-transmitting area T151′, and the light-transmitting area T251′ may be referred to as a fourteenth light-transmitting area T251′. In addition, please refer to the description of the offset in FIGS. 2 to 5.

Referring to FIG. 17, which is a schematic cross-sectional view of the light-controlling structure LCS4 according to some embodiments of the present disclosure. FIG. 17 shows a schematic cross-sectional view taken along line segment III-III′ shown in FIG. 16. In some embodiments, the light source (for example, the backlight structure 30 shown in FIG. 7) may provide the first light L1 and the second light L2. In some embodiments, the second surface 10S2 of the substrate 10 may be used to receive the first light L1 and the second light L2.

As shown in FIG. 17, in some embodiments, in the first region A1, the light-transmitting areas T111-T1mn partially overlap the light-transmitting areas T211-T2mn, so that the first light L1 passing through the light-transmitting areas T111-T1mn and the light-transmitting areas T211-T2mn emits toward the first expected viewing angle position P1. In some embodiments, in the second region A2, the light-transmitting areas T11l′-T1mn′ partially overlap the light-transmitting areas T211′-T2mn′, so that the second light L2 passing through the light-transmitting areas T111′-T1mn′ and the light-transmitting areas T211′-T2mn′ emits toward a second expected viewing angle position P2 different from the first expected viewing angle position P1.

As shown in FIG. 17, in some embodiments, in the first region A1, the first light-transmitting area T151 partially overlaps the second light-transmitting area T251, so that the first light L1 passing through the first light-transmitting area T151 and the second light-transmitting area T251 emits toward the first expected viewing angle position P1. In other words, the first light L1 may pass through the substrate 10 in the first region A1, then pass through the first light-adjusting layer LAL1 in the first region A1, and then pass through the second light-adjusting layer LAL2 in the first region A1, thereby emitting the emitted light L1′. In some embodiments, in the second area A2, the thirteenth light-transmitting area T151′ partially overlaps the fourteenth light-transmitting area T251′, so that the second light L2 passing through the thirteenth light-transmitting area T151′ and the fourteenth light-transmitting area T251′ emits toward the second expected viewing angle position P2. In other words, the second light L2 may pass through the substrate 10 in the second region A2, then pass through the first light-adjusting layer LAL1 in the second region A2, and then pass through the second light-adjusting layer LAL2 in the second region A2, thereby emitting the emitted light L2′.

As shown in FIGS. 16 and 17, in some embodiments, in the first direction D1, the thirteenth light-transmitting area T151′ has an eleventh edge E11 away from the third reference position RP3, and the fourteenth light-transmitting area T251′ has a twelfth edge E12 away from the third reference position RP3. There may be a sixth offset OS6 between the eleventh edge E11 and the twelfth edge E12. The sixth offset OS6 may be greater than 0. The twelfth edge E12 is closer to the third reference position RP3 than the eleventh edge E11. The sixth offset OS6 may be the same as or different from the first offset OS1.

As shown in FIGS. 16 and 17, in some embodiments, in the second direction D2, the thirteenth light-transmitting area T151′ has a thirteenth edge E13 away from the fourth reference position RP4, and the fourteenth light-transmitting area T251′ has a fourteenth edge E14 away from the fourth reference position RP4. There may be a seventh offset OS7 between the thirteenth edge E13 and the fourteenth edge E14. The fourteenth edge E14 is closer to the fourth reference position RP4 than the thirteenth edge E13. The seventh offset OS7 may be greater than 0. The seventh offset OS7 may be the same as or different from the third offset OS3.

As shown in FIG. 17, in some embodiments, the first light-adjusting layer LAL1 includes a seventh light-shielding area S17. The seventh light-shielding area S17 may be disposed between the third light-transmitting area T155 in the first region A1 and the thirteenth light-transmitting area T151′ in the second region A2, and the seventh light-shielding area S17 is disposed adjacent to the third light-transmitting area T155 and the thirteenth light-transmitting area T151′. In some embodiments, the second light-adjusting layer LAL2 includes an eighth light-shielding area S18. The eighth light-shielding area S18 is disposed between the fourth light-transmitting area T255 in the first region A1 and the fourteenth light-transmitting area T251′ in the second region A2, and the eighth light-shielding area S18 is disposed adjacent to the fourth light-transmitting area T255 and the fourteenth light-transmitting area T251′. The seventh light-shielding area S17 may partially overlap the eighth light-shielding area S18 and partially not overlap the eighth light-shielding area S18. In the first direction D1, the width of the eighth light-shielding area S18 may be greater than the width of the seventh light-shielding area S17.

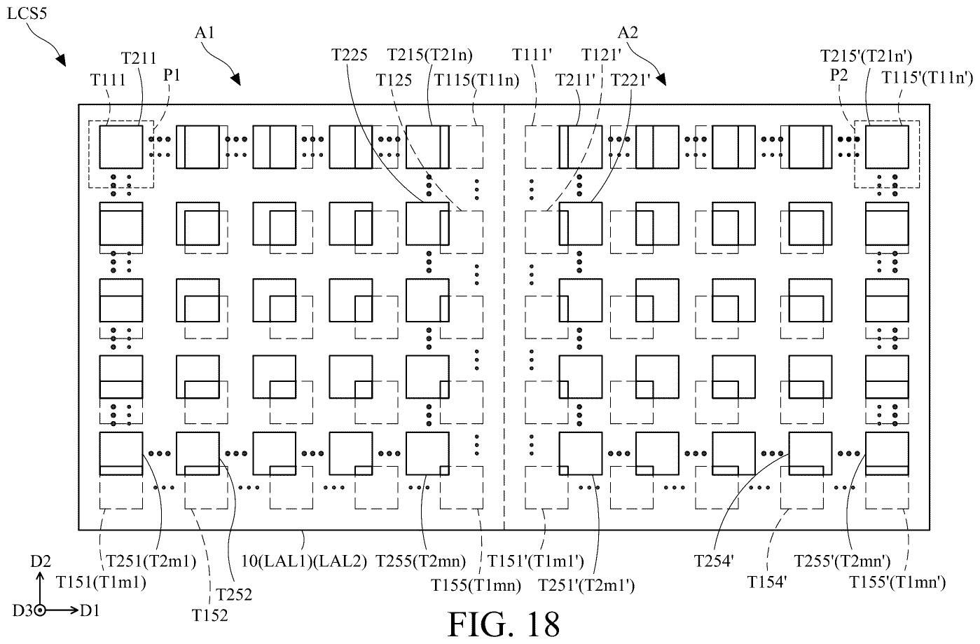

Referring to FIG. 18, which is a schematic top view of a light-controlling structure LCS5 according to some embodiments of the present disclosure. As shown in FIG. 18, the first expected viewing angle position P1 and the second expected viewing angle position P2 may be respectively disposed at the corners of the light-controlling structure LCS5. Accordingly, the expected viewing angle position in the light-controlling structure may be adjusted according to usage requirements. FIG. 18 shows the first region A1 and the second region A2, which respectively have different expected viewing angle positions (for example, the first expected viewing angle position P1 and the second expected viewing angle position P2). For relevant descriptions of the first light-adjusting layer LAL1 and the second light-adjusting layer LAL2, please refer to the above descriptions. The offset between the light-transmitting area TA1 in the first light-adjusting layer LAL1 and the light-transmitting area TA2 in the second light-adjusting layer LAL2 may be designed according to requirements.

According to some embodiments, referring to FIG. 18, in the first region A1, a greater offset may be designed between the light-transmitting area TA1 and the light-transmitting area TA2 that are farther away from the first expected viewing angle position P1, and a smaller offset may be designed between the light-transmitting area TA1 and the light-transmitting area TA2 that are closer to the first expected viewing angle position P1. For example, in the first direction D1, the offset between the light-transmitting areas T155 and T255 that are farther away from the first expected viewing angle position P1 may be greater than the offset between the light-transmitting area T152 and the light-transmitting area T252 that are closer to the first expected viewing angle position P1. For example, in the second direction D2, the offset between the light-transmitting area T155 and the light-transmitting area T255 that are further away from the first expected viewing angle position P1 may be greater than the offset between the light-transmitting area T125 and the light-transmitting area T255 that are closer to the first expected viewing angle position P1.

According to some embodiments, referring to FIG. 18, in the second region A2, a greater offset may be designed between the light-transmitting area TA1 and the light-transmitting area TA2 which are farther away from the second expected viewing angle position P2, and a smaller offset may be designed between the light-transmitting area TA1 and the light-transmitting area TA2 that are closer to the second expected viewing angle position P2. For example, in the first direction D1, the offset between the light-transmitting area T151′ and the light-transmitting area T251′ that are farther away from the second expected viewing angle position P2 may be greater than the offset between the light-transmitting area T154′ and the light-transmitting area T254′ that are closer to the second expected viewing angle position P2. For example, in the second direction D2, the offset between the light-transmitting area T151′ and the light-transmitting area T251′ that are farther away from the second expected viewing angle position P2 may be greater than the offset between the light-transmitting area T121′ and the light-transmitting area T221′ that are closer to the second expected viewing angle position P2.

According to some embodiments, through designing the offset between the light-transmitting areas in the at least two light-adjusting layers, the emitted light passing through the light-transmitting areas in the at least two light-adjusting layers may be shifted toward an expected viewing angle position. At the expected viewing angle position, greater brightness of the emitted light may be obtained. According to some embodiments, the angle of the light passing through the light-controlling structure (the traveling direction of the light), the light flux, and/or other optical parameters may be adjusted by providing a light-controlling structure including at least two light-adjusting layers (for example, the first light-adjusting layer and the second light-adjusting layer). Therefore, the convergent viewing angle position of the electronic device may be adjusted to the expected viewing angle position and/or the emitting uniformity of the electronic device may be improved. For example, the light-transmitting areas of each light-adjusting layer of the present disclosure may partially overlap, so that the light passing through each light-transmitting area emits toward the expected viewing angle position.

The features among the various embodiments of the present disclosure may be arbitrarily combined as long as they do not violate or conflict with the spirit of the disclosure. In addition, the scope of the present disclosure is not limited to the process, machine, manufacturing, material composition, device, method, and step in the specific embodiments described in the specification. A person of ordinary skill in the art will understand current and future processes, machine, manufacturing, material composition, device, method, and step from the content disclosed in some embodiments of the present disclosure, as long as the current or future processes, machine, manufacturing, material composition, device, method, and step performs substantially the same functions or obtain substantially the same results as the present disclosure. Therefore, the scope of the present disclosure includes the above-mentioned process, machine, manufacturing, material composition, device, method, and steps. The protection scope of the present disclosure shall be determined by the scope of the claims. It is not necessary for any embodiment or claim of the present disclosure to achieve all of the objects, advantages, and/or features disclosed herein.

The foregoing outlines features of several embodiments of the present disclosure, so that a person of ordinary skill in the art may better understand the aspects of the present disclosure. A person of ordinary skill in the art should appreciate that, the present disclosure may be readily used as a basis for designing or modifying other processes and structures for carrying out the same purposes and/or achieving the same advantages of the embodiments introduced herein. A person of ordinary skill in the art should also realize that such equivalent constructions do not depart from the spirit and scope of the present disclosure, and that they may make various changes, substitutions, and alterations herein without departing from the spirit and scope of the present disclosure.

What is claimed is:

1. An electronic device comprising a light-controlling structure, and wherein the light-controlling structure comprises:
a substrate;
a first light-adjusting layer disposed on a first surface of the substrate, wherein the first light-adjusting layer has a first light-transmitting area; and
a second light-adjusting layer disposed on the first light-adjusting layer, wherein the second light-adjusting layer has a second light-transmitting area, and the first light-transmitting area partially overlaps the second light-transmitting area,
wherein in a first direction, the first light-transmitting area has a first edge away from a first reference position, and the second light-transmitting area has a second edge away from the first reference position, a first offset is between the first edge and the second edge, and the first offset is greater than 0.

2. The electronic device as claimed in claim 1,
wherein the first light-adjusting layer has a third light-transmitting area, the second light-adjusting layer has a fourth light-transmitting area, and the third light-transmitting area partially overlaps the fourth light-transmitting area,
wherein in the first direction, the third light-transmitting area has a third edge away from the first reference position, the fourth light-transmitting area has a fourth edge away from the first reference position, and a second offset is between the third edge and the fourth edge, and the second offset is greater than 0, and
wherein in the first direction, the second edge is closer to the first reference position than the first edge, and the fourth edge is closer to the first reference position than the third edge.

3. The electronic device as claimed in claim 2,
wherein the first light-adjusting layer comprises a first light-shielding area disposed adjacent to the first light-transmitting area, and
wherein the second light-adjusting layer comprises a second light-shielding area disposed adjacent to the second light-transmitting area, and in the first direction, a width of the second light-shielding area is greater than a width of the first light-shielding area.

4. The electronic device as claimed in claim 3,
wherein the first light-adjusting layer comprises a third light-shielding area disposed adjacent to the third light-transmitting area, and
wherein the second light-adjusting layer comprises a fourth light-shielding area disposed adjacent to the fourth light-transmitting area, and in the first direction, a width of the fourth light-shielding area is greater than a width of the third light-shielding area.

5. The electronic device as claimed in claim 2,
wherein the first light-adjusting layer has a fifth light-transmitting area, the second light-adjusting layer has a sixth light-transmitting area, and the fifth light-transmitting area at least partially overlaps the sixth light-transmitting area, and
wherein in the first direction, the fifth light-transmitting area is located between the first light-transmitting area and the third light-transmitting area, and the sixth light-transmitting area is located between the second light-transmitting area and the fourth light-transmitting area, and the fifth light-transmitting area is aligned with the sixth light-transmitting area in the first direction.

6. The electronic device as claimed in claim 1, further comprising:
a light source providing a light; and
a display panel, wherein the light-controlling structure is disposed between the light source and the display panel,
wherein the substrate comprises a second surface, the second surface is corresponding to the first surface, the second surface is closer to the light source than the first surface, and the second surface receives the light.

7. The electronic device as claimed in claim 1, wherein the first light-adjusting layer further comprises:
a first light-shielding layer having a first opening, wherein the first opening defines the first light-transmitting area; and
a first light-transmitting unit disposed in the first opening.

8. The electronic device as claimed in claim 1, wherein the first light-adjusting layer further comprises:
a light-controlling medium, wherein the light-controlling medium generates the first light-transmitting area using electrical energy.

9. The electronic device as claimed in claim 1, wherein the first offset is in a range of 0.05 um-100 um.

10. The electronic device as claimed in claim 1, wherein:
in a second direction different from the first direction, the first light-transmitting area has a fifth edge away from a second reference position, and the second light-transmitting area has a sixth edge away from the second reference position, a third offset is between the fifth edge and the sixth edge, and the third offset is greater than 0.

11. The electronic device as claimed in claim 10, wherein the third offset is in a range of 0.05 um-100 um.

12. The electronic device as claimed in claim 1,
wherein the first light-adjusting layer has a ninth light-transmitting area, the second light-adjusting layer has a tenth light-transmitting area, and the ninth light-transmitting area partially overlaps the tenth light-transmitting area, and
wherein in the first direction, the ninth light-transmitting area is disposed adjacent to the first light-transmitting area, the tenth light-transmitting area is disposed adjacent to the second light-transmitting area, the ninth light-transmitting area has a seventh edge away from the first reference position, the tenth light-transmitting area has an eighth edge away from the first reference position, a fourth offset is between the seventh edge and the eighth edge, the fourth offset is greater than 0, and the first offset is greater than the fourth offset.

13. The electronic device as claimed in claim 12,
wherein the first light-adjusting layer has an eleventh light-transmitting area, the second light-adjusting layer has a twelfth light-transmitting area, and the eleventh light-transmitting area partially overlaps the twelfth light-transmitting area, and
wherein in the second direction, the eleventh light-transmitting area is disposed adjacent to the first light-transmitting area, the twelfth light-transmitting area is disposed adjacent to the second light-transmitting area, the eleventh light-transmitting area has a ninth edge away from the second reference position, the twelfth light-transmitting area has a tenth edge away from the second reference position, a fifth offset is between the ninth edge and the tenth edge, the fifth offset is greater than 0, and the third offset is greater than the fifth offset.

14. The electronic device as claimed in claim 13,
wherein the first light-adjusting layer has a seventh light-transmitting area, the second light-adjusting layer has an eighth light-transmitting area, the seventh light-transmitting area and the eighth light-transmitting area are located at an expected viewing angle position, and the expected viewing angle position overlaps the first reference position, wherein an offset between the seventh light-transmitting area and the eighth light-transmitting area in the first direction is 0 or smaller than the fourth offset.

15. The electronic device as claimed in claim 14,
wherein the expected viewing angle position overlaps the second reference position, and
wherein an offset between the seventh light-transmitting area and the eighth light-transmitting area in the second direction is 0 or smaller than the fifth offset.

16. The electronic device as claimed in claim 12,
wherein the first light-adjusting layer comprises a fifth light-shielding area disposed between the first light-transmitting area and the ninth light-transmitting area, and
wherein the second light-adjusting layer comprises a sixth light-shielding area disposed between the second light-transmitting area and the tenth light-transmitting area.

17. The electronic device as claimed in claim 16,
wherein the first light-adjusting layer further comprises: a first light-shielding layer comprising a plurality of first openings, the plurality of first openings defines a plurality of light-transmitting areas, and the plurality of light-transmitting areas of the first light-adjusting layer comprises the first light-transmitting area and the ninth light-transmitting area, and
wherein the second light-adjusting layer further comprises: a second light-shielding layer comprising a plurality of second openings, the plurality of second openings defines a plurality of light-transmitting areas, and the plurality of light-transmitting areas of the second light-adjusting layer comprises the second light-transmitting area and the tenth light-transmitting area.

18. The electronic device as claimed in claim 1, further comprising:
a reflective layer disposed between the substrate and the first light-adjusting layer; and
a light-transmitting layer disposed between the first light-adjusting layer and the second light-adjusting layer.

19. The electronic device as claimed in claim 2,
wherein the substrate has a first region and a second region, the first reference position is located in the first region, and a third reference position is located in the second area,
wherein the first light-transmitting area and the third light-transmitting area of the first light-adjusting layer are disposed in the first region, and the second light-transmitting area and the fourth light-transmitting area of the second light-adjusting layer are disposed in the first region,
wherein the first light-adjusting layer has a thirteenth light-transmitting area, the thirteenth light-transmitting area is disposed in the second region, the second light-adjusting layer has a fourteenth light-transmitting area, and the fourteenth light-transmitting area is disposed in the second area, and
wherein in the first direction, the thirteenth light-transmitting area has an eleventh edge away from the third reference position, the fourteenth light-transmitting area has a twelfth edge away from the third reference position, a sixth offset is between the eleventh edge and the twelfth edge, the sixth offset is greater than 0, and the twelfth edge is closer to the third reference position than the eleventh edge.

20. The electronic device as claimed in claim 19,
wherein the first light-adjusting layer comprises a seventh light-shielding area disposed adjacent to and between the third light-transmitting area in the first region and the thirteenth light-transmitting area in the second region, and
wherein the second light-adjusting layer comprises an eighth light-shielding area disposed adjacent to and between the fourth light-transmitting area in the first region and the fourteenth light-transmitting area in the second region, and the seventh light-shielding area partially overlaps the eighth light-shielding area.
